(19) United States
(12) Patent Application Publication
(10) Pub. No.: US 2011/0283825 A1
(43) Pub. Date: Nov. 24, 2011

(54) Linkage

(75) Inventor: Steven Corcoran, Cawood (GB)

(73) Assignee: CORCOST LIMITED, Cawood (GB)

(21) Appl. No.: 13/145,256

(22) PCT Filed: Feb. 12, 2010
(86) PCT No.: PCT/GB2010/000248

§ 371 Date: Jul. 19, 2011

(30) Foreign Application Priority Data
Feb. 16, 2009 (GB) 0902436.5
Feb. 16, 2009 (GB) 0902445.6
Feb. 16, 2009 (GB) 0902446.4
Feb. 16, 2009 (GB) 0902448.0
Feb. 17, 2009 (GB) 0902618.8

(51) Int. Cl. F16H 35/06

(52) U.S. Cl. 74/396

(57) ABSTRACT

A linkage includes two gearboxes each having a driven shaft, and at least one linear actuator connected between the gearboxes. Actuation of the at least one linear actuator adjusts the relative position of the driven shafts for the two gearboxes with respect to each other.

### FIELD OF THE INVENTION

The present invention relates to a linkage. Linkages have many applications in a variety of mechanical devices, including hoists or lifting apparatus, surfaces such as support surfaces and in robotic applications.

### BACKGROUND

In the simplest form, a linkage may comprise two components, for example two arms, that are pivotally connected together, such as the links of a bicycle chain. However with such an arrangement the relative movement between the two components is limited to a pure uncontrolled pivotal movement between the components. More complicated linkages include a four-bar linkage arrangement in which the end of each of the four bars is pivotally connected to the end of another of the four bars, for example in a parallelogram arrangement, allowing a greater variety of movement of the links with respect to each other than in a simple pivoting arrangement but like the pivoting arrangement these are fixed movements. These four bar linkages may be driven, for example using an external motor, to cause movement of the components of the linkage with respect to each other. The four bar linkages are complex and sequential. The four bar linkage is of low movement capability, is of high weight and needs a large amount of space for operation and storage as well as being prone to error and wear.

The alteration of the four bar linkage is difficult and the alteration of one section unless minor will mean that another section is not capable of operating correctly and therefore the overall linkage will not operate. If a minor alteration is completed that will alter the movement of all other parts of the linkage and thus each part of the linkage does not operate independently. This leads to the four bar linkage being for a fixed operation and therefore application. Any particular four bar linkage is therefore non-modular with a very narrow range and performance band. Other linkages may use cables but again the systems are sequential, heavy, require calibration, are of low functionality, are of a narrow performance range and are prone to errors and uncontrollable movement. They are limited to application and like the four bar linkage, a cable linkage used in one application cannot simply be used to another. The cable linkage further requires a frame and cannot operate without a second means of support and this adds to the weight and complexity of a cable system.

### SUMMARY OF THE INVENTION

According to a first aspect of the present invention, there is provided a linkage including a first gearbox having a first driven shaft, a second gearbox having a second driven shaft, and at least one linear actuator connected between the first gearbox and the second gearbox arranged such that the actuation of the at least one linear actuator adjusts the relative position of the first and second driven shafts.

With the linkage of the present invention, the use of a linear actuator connecting two gearboxes means that the relative position of the two gearboxes, and in particular the relative position of the driven shafts of the two gearboxes can be easily varied. This is advantageous in that is allows control of the position of the driven shafts, for example control of their relative separation and angle, and thereby provides a versatile linkage arrangement.

It is preferred that the linear actuators are self-locking or otherwise able to be maintained in a fixed position for power saving and establishment of a stable work platform. Further for example in the event of a power failure, to ensure that the position of the gearboxes remains fixed in such an event.

It is preferred that at least two linear actuators are provided between the first and second gearboxes, the linear actuators being arranged such that the actuation of one or more of the linear actuators adjusts the relative position of the first and second driven shafts.

The inclusion of two or more linear actuators between the first and second gearbox gives additional strength to the connection between the gearboxes, which may be particularly beneficial where the gearboxes are intended to carry or support heavy loads. Additionally, the use of multiple linear actuators can help avoid undesirable movement, for example twisting, of one gearbox with respect to the other gearbox.

It is preferred that at least one end of at least one linear actuator is pivotally connected to one of the gearboxes. By pivotally connected the linear actuator to the gearbox, the gearbox can pivot with respect to the linear actuator, giving even greater versatility in the relative position of the first and second driven shafts. In this case, it is preferred that the at least one end of the at least one linear actuator is connected to a driven shaft of one of the gearboxes. This allows the pivoting of the gearbox with respect to the linear actuator to be controlled by the driving of the gearbox, allowing further adjustment of the relative position of the first and second gearbox to be achieved by the gearbox.

It is further preferred that one end of at least one linear actuator is pivotally connected to the first gearbox and the other end of the at least one linear actuator is pivotally connected to the second gearbox. In this case, it is preferred that the pivotal connection to the first gearbox and/or the pivotal connection to the second gearbox is formed by connection to the driven shaft of the respective gearbox. The pivotal connection of the ends of the linear actuator to the respective gearbox allows further versatility in the positioning of the gearboxes with respect to each other, and where the connection is via the driven shaft of the gearboxes allows the drive of the gearboxes to move the gearboxes with respect to each other.

Where a plurality of linear actuators are connected between the first and second gearboxes, it is advantageous for at least one, and preferably each, of the linear actuators to be pivotally connected with respect to at least one and preferably each of the gearboxes. This enables the differential actuation of the linear actuators to cause greater versatility of relative movement between the first and second gearboxes. For example, one of the linear actuators can be extended as the other linear actuator is retracted, resulting in the twisting or angling of one gearbox with respect to the other gearbox.

Where a plurality of linear actuators are provided between the first and second gearboxes, it is preferred that a further linear actuator is provided between the linear actuators to enable to linear actuators to be moved with respect to each other. In this case, the additional linear actuator may be used to move the linear actuators between the first and second gearboxes from an orientation in which they are parallel to each other to an orientation in which they are not parallel to each other. This provides even greater versatility and control of the relative movement of the gearboxes. This may include a simple twisting movement or even a figure of eight motion depending upon the number and arrangement of actuators.

It is preferred that the first and second gearboxes are pivotally connected by a pivoting joint, such as a hinge or a ball and socked type joint. The inclusion of a pivotal connection between the first and the second gearboxes will restrict the relative movement of the first and second gearboxes, and typically will prevent variation of the distance between the gearboxes through the pivot point however will allow the relative movement of the gearboxes about the pivot point, the relative movement being caused by the actuation of the at least one actuator. For example, the pivot may be a hinge having an axis angled with respect to the first and second gearboxes, for example extending generally perpendicular to a line between the first and second gearboxes. In this case, the or at least one of the linear actuators should be offset from the axis of the hinge. In this case, actuator of the at least one linear actuator will result in the pivoting of the first and gearboxes with respect to each other about the hinge. Where the pivoting joint is a ball and socket type joint, the pivoting of the gearboxes with respect to each other can be about multiple axes of the ball rather than about a single axis where a hinge joint is used.

It is preferred that at least one additional linear actuator is connected to the first or the second gearbox. In this case, it is preferred that a further gearbox is connected to the at least one additional linear actuator. Where an additional linear actuator is connected to the first or second gearbox, this additional linear actuator will be moved with the gearbox to which it is connected. For example, where the additional linear actuator is connected to the second gearbox, the second gearbox can be moved with respect to the first gearbox by extension or retraction of the linear actuator provided between the first and second gearbox and, where the first linear actuator is pivotally connected to the first and/or second gearbox, by the pivoting of the first and/or second gearbox with respect to the linear actuator. This movement of the second gearbox with respect to the first gearbox will result in the relative movement of the additional linear actuator, and anything connected to the further actuator. Where the further linear actuator is connected to a further gearbox, it will be appreciated that the further gearbox may be moved with respect to the second gearbox in a manner similar as described above for the movement of the second gearbox with respect to the first gearbox. This would therefore result in a chain of gearboxes each connected by at least one linear actuator with the gearboxes being movable with respect to each other by the actuation of the linear actuators and, optionally, by the pivoting of the linear actuators with respect to the gearboxes.

It will be appreciated that any number of additional linear actuators and gearboxes may be connected to provide a chain of gearboxes of any desired length.

Where the linkage includes a first gearbox, a second gearbox and a third gearbox with a first linear actuator connected between the first gearbox and the second gearbox and a second linear actuator connected between the second gearbox and the third gearbox, it is preferred that the first linear actuator is offset from the second linear actuator such that the third gearbox can be located between the first and the second gearbox.

This arrangement allows the chain of gearboxes and linear actuators to be folded to reduce the overall space occupied by the chain of gearboxes when not in use. In particular, rather than requiring that the third gearbox be positioned beyond the first and second gearboxes, the third gearbox can be positioned between the first and second gearbox such that the overall size of the chain is no greater than the size of the first and second gearbox and intervening linear actuator. It will be appreciated that even then the gearboxes are folded in this way, the gearboxes and linear actuators may still be driven to move the gearboxes and linear actuators with respect to each other. Furthermore this arrangement can give greater versatility in the movement of the gearboxes in the chain compared to an arrangement in which the linear actuators are not offset, in which case the movement of one linear actuator may be restricted by other linear actuators.

It will be appreciated that the drive of one gearbox can be independent of the drive of another gearbox and of the actuation of the linear actuator connecting the gearboxes. Therefore, an output of a second gearbox can be moved by the second gearbox irrespective of the movement or the first gearbox or linear actuator between the first or second gearbox.

Whilst the gearbox can be any suitable gearbox, it is preferred that the gearbox is a self-locking gearbox in which the driven shaft will only rotate when driven or a gearbox with a holding capability that allows the driven shaft to be locked in place. Advantageously, the gearbox is one having additional features to assist with the driving of the gearbox, for example energy storage means that can selectively store and release energy to assist with the driving of the shaft. Preferably the gearbox is as described in our co-pending application entitled “Gearbox”.

Whilst the linear actuator can be any suitable linear actuator, it is preferred that the linear actuator is as described in our co-pending application entitled “Linear Actuator”.

According to a further aspect of the invention, there is provided a lifting mechanism, such as a hoist, including a linkage according to the first aspect of the present invention in which the driven shaft of the first gearbox is mounted to a base such that the driving of the shaft will cause the rotation of the first gearbox about the shaft with respect to the base, or in which the linear actuator connected between the first gearbox and a second gearbox is connected to the driven output of the first gearbox such that the driving of the shaft will cause the rotation of the linear actuator about the shaft, in either case such that the driving of the shaft of the first gearbox will cause the movement of the linear actuator and therefore the movement of the second gearbox connected to the linear actuator with respect to the base.

A hoist or other lifting mechanism according to this aspect of the present invention is particularly advantageous compared to known lifting mechanisms in that the ability to move the second gearbox with respect to the first gearbox by both driving of the first gearbox and the actuation of the linear actuator between the first and second gearboxes provides greater control of the movement and positioning of the second gearbox than may otherwise be the case. This can allow greater control of a lifting movement used by the hoist or lifting mechanism to lift or more a load.

In this case, the second gearbox preferably includes an arm for connection to a further gearbox or lifting means, such as a hook. The arm may be a further linear actuator. In this case, the linear actuator between the first and second gearbox may be connected to the driven shaft of the second gearbox, such that the driving of the second gearbox causes the second gearbox to rotate about the driven shaft, and thereby causes the rotation of the arm.

The provision of a chain of gearboxes with linear actuators between adjacent gearboxes to permit the relative position and movement of one gearbox with respect to an adjacent gearbox increases the versatility of the movement and positioning of the gearboxes of the hoist or lifting mechanism and therefore gives even greater control of the lifting profile of the mechanism. Alternatively or additionally, the arm may be connected to the driven shaft of the final gearbox, such as the second or, where provided third, gearbox, such that the drive of the final gearbox causes the rotation of the arm. In this way, the drive of the driven shaft of the final gearbox causes the pivoting movement of the arm to position and move the arm as required for the lifting operation.

Whilst this aspect of the invention has been described as a lifting operation, it will be appreciated that the movement is not limited to a vertical lifting operation, and could be a lowering operation or a movement in any other desired direction, such as a sideways movement, or in a combination of directions such as a sideways and lowering movement. The overall movement is determined by the drive of each of the driven shafts and the movement of each of the linear actuators, meaning that the movement or lifting profile can be controlled as desired.

It will be appreciated that suitable computer or other electronic control of the gearboxes and/or linear actuators can achieve the desired lifting profile.

In a further aspect of the present invention, there is provided a surface including a first surface section and a second surface section, and a linkage according to the first aspect of the present invention, the first surface section being mounted with respect to the first gearbox and the second surface section being mounted with respect to the second gearbox arranged such that the first and second surface sections are moveable with respect to each other as the first and second gearboxes are moved with respect to each other

Since the relative position of the gearboxes may be varied through operation of the at least one linear actuator connected between the gearboxes, and/or the drive of at least one of the gearboxes, this variation will vary the relative position of the first and second surface sections, thereby allowing variation of the surface.

For example, the surface may be used to define a support surface of a bed or chair for supporting a person, and in this case the support sections may be provided to support different parts of the person. For example, the first surface section may be provided to support a person's thigh, whilst the second surface section may be provided to support the person's lower leg. In this case, the first and second surface sections may be positioned with respect to each other depending upon the size of the person so that the surface sections correspond to the position of the person's upper and lower legs. Alternatively or additionally the first and second surface sections can be moved with respect to each other to move the person's leg, for example to straighten this as the person reclines.

In this aspect, the first and second surface sections can be fixedly mounted to the first and second gearboxes respectively, or can be mounted to the first and second gearboxes in a manner permitting some relative movement between the surface section and the gearbox, for example using a linear actuator mounting arrangement to allow the surface section to be moved with respect to the gearbox. Connecting the surface sections to the respective gearboxes in a manner permitting the relative movement of the surface section with respect to the gearbox provides additional degrees of movement of the surface section for increased versatility.

In this aspect of the invention, it will be appreciated that additional surface sections may be provided on additional gearboxes connected using additional linear actuators. This can be used to provide larger surfaces including further surface sections, or a surface which has an even greater degree of movement due to the additional surface sections.

It will be appreciated that where additional gearboxes are provided, these may alternatively be provided connected directly to one of the existing gearboxes. This can be used to form a double gearbox arrangement having two driven shafts that are independently drivable. This can increase the versatility of movement of one support section with respect to an adjacent surface section.

As well as using the arrangement of gearboxes and linear actuators to control the movement of a surface, the arrangement can be used to maintain the position of a surface. For example, if a load is applied to the surface, the arrangement can be used to counteract the effect of the load and maintain the position of the surface. For example, if the surface is used to support a person and is moved to move the person from a sitting to a standing position, if the person is slightly offset from a normal position on the support, the support can be adjusted slightly to shim the person.

Whilst this aspect of the invention has been described with respect to a support surface, it will be appreciated that the surface is not limited to being a surface for supporting a weight. Alternatively the surface may be a decorative surface, such as the surface of a wall, vehicle, building, armour or other article where it is desired to be able to control or vary the contour of the overall support surface.

### BRIEF DESCRIPTION OF THE DRAWINGS

Embodiments of the invention will now be described by way of example only with reference to the accompanying drawings, in which:

FIG. 1 depicts a plan section view of a gearbox;

FIG. 2 depicts a side view of a gearbox;

FIG. 3 depicts a plan section view of a plurality gearbox

FIG. 4 depicts a plan view of a plurality gearbox;

FIG. 5 depicts a side view of a linear actuator;

FIG. 6 depicts movement directions;

FIG. 7 depicts a plan view of the first linkage embodiment;

FIG. 8 depicts a plan view a configuration of the first embodiment;

FIG. 9 depicts a side view of the configuration from FIG. 8;

FIG. 10 depicts a front view of the configuration FIG. 8 folded;

FIG. 11 depicts a side view of the second embodiment;

FIG. 12 depicts a side view of the second embodiment in a different configuration;

FIG. 13 depicts a plan view of the second embodiment in a different configuration;

FIG. 14 depicts a plan view of the second embodiment in a different configuration;

FIG. 15 depicts a plan view of a different configuration from FIG. 14;

FIG. 16 depicts a plan view of the third embodiment;

FIG. 17 depicts a plan view of the fourth embodiment;

FIG. 18 depicts a plan view of the fourth embodiment;

FIG. 19 depicts a plan view of the fourth embodiment;

FIG. 20 depicts a plan view of the fourth embodiment;

FIG. 21 depicts a plan view of the fourth embodiment;

FIG. 22 depicts a plan view of the fourth embodiment;

FIG. 23 depicts a plan view of the fourth embodiment;

FIG. 24 depicts a plan view of the fourth embodiment as a multi-axe formation;

FIG. 25 depicts a side view of the movement of the multi-axes formation from FIG. 24.

### DETAILED DESCRIPTION

In the following description, except where otherwise stated or where otherwise apparent from the context, any reference to components being attached should be understood to cover permanent attachment, for example by welding or through the use of a bonding agent or adhesive, and removable attachment for example using a mechanical attachment such as a friction fit, bolt, screw or the like. Further, except where otherwise apparent from the context, permanent attachment may include the components being integrally formed.

All the components and/or assemblies or linkages unless otherwise stated have a casing or housing 14 which has at least one portion but typically will have at least two portions. The casing or housing 14 as well as any component and/or assembly or linkage can feature an electrical circuit to enable electrical connectivity for reception and transmission of power and data to and/or from other devices and/or any component and/or assembly or linkages thereby collectively forming a power and/or data grid.

The electrical circuit is able to be encapsulated in the said component and/or assembly or linkage or device or casing or housing 14 and is able to include at least one sensor and/or at least one microchip and/or at least one circuit and/or at least one circuit board and/or at least one electrical energy storage means such as at least one battery whereby an internal or localised data and/or power grid is able to be formed.

The electrical elements can also feature memory and therefore the electrical elements 3 can store data and allow that data to be used by itself or other devices in the at least one data grid as well as access stored data in other devices within the at least one data grid and/or be accessed to retrieve and/or store data specifically for other devices.

The electrical elements can link to at least one computer and can be programmed to perform in a certain manner and/or operate accordingly and/or operate as a function of its own programming with relation to feedback from at least one sensor and/or memory and/or processed output and/or input from at least one computer and/or from at least one data grid.

In the following, where reference is made to bearings, these can be any suitable bearings which may include roller bearings, ball bearings, plan bearings or needle bearings. The bearings for any component may be the same or could be of different size and/or type.

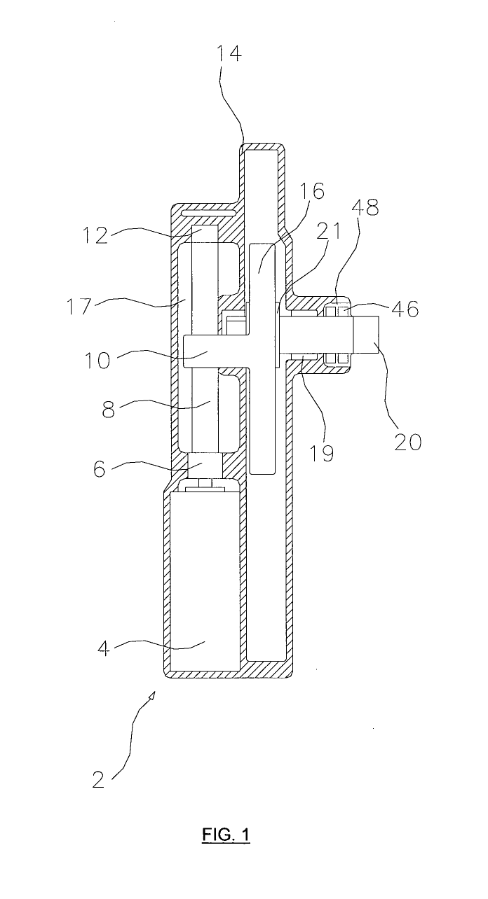

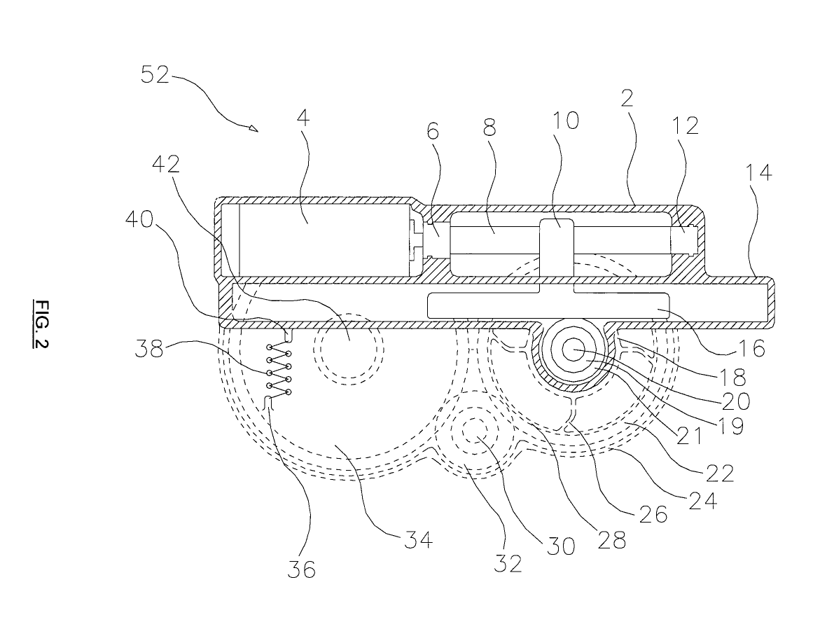

FIGS. 1 and 2 shows a gearbox 52 which is able to used in the present invention, however, the present invention is not limited to use this gearbox. It will be appreciated that other configurations are able to be used for the gearbox and these will be described later in the description.

FIG. 1 and FIG. 2 shows one such suitable at least one gearbox 2, 52 and having at least one housing 14. The gearbox 2 is shown including an at least one actuator 4, at least one leadscrew 8, at least one drive rack nut 10, at least one toothed section 16, at least one gear 21 and an at least one output shaft 20.

It will be appreciated from the drawings that the hatched section shows the actuator element of gearbox 2 where the dotted lines show at least one drive train element with gears such as at least one gear 34 and at least one gear 32 that can be additional to the actuator element to form gearbox 52. The actuator element of FIG. 1 can be used as shown and without a plurality of gears. The drive train element will be described later in the description with this part of the description concentred on the actuator element gearbox shown with the hatched area.

The actuator element includes at least one gear 21 which is attached to or integrated with the shaft 20. The gear 21 can feature at least one integrated gear tooth surface. As the gear 21 is rotated, the shaft 20 will be rotated.

Where the gear 21 is integrated with the shaft 20, the gear 21 can be cut into the shaft 20. Where the gear 21 is attached to the shaft 20, the gear 21 can be secured to the shaft 20 in any suitable manner.

The shaft 20 may be mounted in the housing 14 on at least one bearing 19. The bearing 19 can be located at both sides of the shaft 20. In this example, the shaft 20 can also form the output means of the gearbox. It is also possible for the output means to comprise a further shaft section removably or permanently attached to the shaft 20.

Where the shaft 20 and/or other output means extends from the gearbox, it is preferred to include a seal which permits the rotation of the shaft 20 and/or other output means whilst avoiding the risk of contaminants passing into or out from the gearbox. As an example, the at least one end cap 48 is provided though which the shaft 20 and/or other output means extends, the end cap including at least one groove to receive a seal 46 such as an O-ring or quad-ring type seal, or including an integrated seal such as a lip seal.

Further to the actuator element is the at least one actuator 4 in this example is a motor, for example an electric motor. It will be appreciated that multiple actuators, for example multiple motors, can be used, and that other actuators can be used, for example a manual actuator such as a handle, engine or the like. The actuator is attached to the leadscrew 8.

This attachment can be via a coupling which can be attached to the leadscrew 8 and/or the actuator 4.

The leadscrew 8 is held by at least one bearing, preferably by two bearings 6, 12. These bearings are mounted in the housing 14. The bearings are shown at both sides of the leadscrew 8. The bearings allow the leadscrew 8 to be held securely whilst allowing for its low friction rotation.

The at least one drive rack nut 10 has a threaded portion, which may be integrally formed with the drive rack nut 10 or may be provided as a separate threaded portion, for example as a threaded insert. The threaded portion meshes with the thread on the leadscrew 8 such that the rotation of the leadscrew 8 results in the longitudinal movement of the drive rack nut 10.

The drive rack nut 10 is attached to a gear toothed section 16. The toothed section 16 meshes with the gear 21. Thus the rotation of the actuator 4 results in the rotation of the leadscrew 8, which causes the longitudinal movement of the drive rack nut 10 and the consequential movement of the toothed section 16. The movement of the toothed section 16 causes the gear 21 to rotate. The rotation of the gear 21 causes rotation of the shaft 20.

The gearbox housing 14 may divide the gearbox 52 into at least one, and typically two, internal chambers. These chambers 17 may hold different parts of the gearbox 52 for example one chamber may hold the actuator 4 whilst another chamber holds the leadscrew 8 and the drive rack nut 10.

The drive rack nut 10 and the toothed section 16 are contained within the gearbox housing 14 so as to be longitudinally slideable. A portion of the gearbox housing may contact the drive rack nut 10 and/or the toothed section 16 to help retain the drive rack 10 and the tooth section 16 centred correctly with respect to the axis of the leadscrew 8, with the toothed section 16 operationally associated with the gear 21. The housing 14, the drive rack nut 10 and/or the toothed section 16 can include a low friction or lubricated surface to ensure that contact results in minimal friction whilst preventing the drive rack nut 10 and the toothed section 16 from rotating about the leadscrew 8 axis.

It will be understood that the arrangement described is self-locking. In particular, if a rotational force is applied to the output shaft 20, this will result in a longitudinal force being applied to the drive rack nut 10 through the meshing of the gear 21 with the toothed section 16. However, since the drive rack nut 10 is threadingly engaged with the leadscrew 8, the drive rack nut 10 cannot be moved longitudinally. The longitudinal movement of the drive rack nut 10 can only be achieved through the rotation of the leadscrew 8. Therefore, in the absence of any drive causing the rotation of the leadscrew 8, even where there is a rotational force applied to the output, the drive rack nut 10 cannot be moved, and therefore there will be no movement of the shaft 20 or other components of the gearbox.

The gearbox 2 can be a plurality of gearboxes where the casing 14 are attached permanently or removably or they can be integrated. Typically the at least two gearboxes will have either one joint output shaft or two independently shafts. In the first case, the at least two gearboxes will be joined output shaft to output shaft and in the second case the gearboxes will be joined on the second side where the exit shaft exits each gearbox on the first side.

FIG. 2 shows the at least one gearbox 52 may feature at least one drive train element as shown via the dotted lines. The drive train may include a plurality of gears. The drive train shown has a gear 22 which is attached to or integrated with shaft 20. In this case with the drive train element, the shaft 20 will no longer be the output shaft. Where the gear 22 is integrated with the shaft 20, the gear 22 can be cut into the shaft 20. Where the gear 21 is attached to the shaft 20, the gear 22 can be secured to the shaft 20 in any suitable manner.

The gear 22 can be attached to or integrated with the gear 21 and in both circumstances the rotation of the gear 21 as described will result in the rotation of the gear 22. The gear 22 is meshed with gear 32 which is in turn meshed with the gear 34 such that rotation of the gear 22 results in the rotation of the gear 32 and subsequently gear 34.

The gears 32 and 34 are attached to or integrated with the shafts 30 and 42 respectively. Where the gears are integrated with the shafts, the gears can be cut into the shafts and where the gears are attached to the shaft, the gears can be secured to the shaft in any suitable manner. The shaft 42 and shaft 30 may be located on bearings at both sides of the gears 32 and 34.

The addition of the plurality of gears means that the output shaft becomes shaft 42 which may have all the same function and features as the shaft 20. The output shaft 42 may therefore feature the end cap 48 with the seals 46 as described above.

Thus the rotation of the actuator 4 results in the rotation of the leadscrew 8, which causes the longitudinal movement of the drive rack nut 10 and the consequential movement of the toothed section 16. The movement of the toothed section 16 causes the gear 21 to rotate. The rotation of the gear 21 causes rotation of the shaft 20 and rotation of the gear 22 which in turn rotates the gear 32 and the gear 34. The gear 34 rotates the output shaft 42 and therefore the rotation of the actuator 4 rotates the output shaft 42.

The gearbox may include at least one energy storage element arranged to store energy during at least part of the rotation of the output shaft to be released during another part of the rotation of the output shaft. The at least one energy storage element may be in the form of at least one spring. The energy storage element can be a pneumatic or hydraulic storage and release element or an electric element such as at least one dynamo coupled to a shaft or gear.

The gearbox 52 shows two energy storage elements, the first 38 being at least one spring that is attached to the gear 34 by the portion 36. It will be appreciated that the spring can be attached to any other gear within the actuator element such as gear 21 or the drive train element such as the gears 22 and 32. The energy storage element is attached at the other end by portion 40 to the housing 14.

As the gear 34 rotates in the first direction the energy element in this case a spring will extend and store energy which will be released into the gearbox when the gear 34 rotates in the opposite direction. Similarly at least one energy element is attached to the gear 22 and this may be attached to any other gear in the actuator element such as gear 21 as well as those other gears in the drive train element 32 and 34.

The energy element has a rotatable component that can be coupled can be coupled to a rotatable or fixed shaft. If the shaft is fixed then the gears 22 and 21 are mounted on the shaft via at least one bearing such that they are able to rotate. As the gear 22 and gear 21 rotate the outer ring 28 attached to the gear 22 rotates. The outer ring is attached to an inner ring 18 which is attached to the shaft 20. The outer ring is attached to the inner ring with tines 26 which may be include at least one angled shape such as a change of direction or at least one fold. As the gear 22 and gear 21 rotates in one direction energy is placed into each tine which is released when the gear 22/21 is rotated in the opposite direction.

The energy element may be used with a shaft that is able to rotate independently of the gear and/or gears to which it is attached. In this case the gear and/or gears may be rotationally mounted on the shaft by bearings and as such the shaft and gears can rotate and in opposite directions or the same direction at different or the same angular velocity and force.

Therefore the rotation relative to the gear and shaft will act on the tines to store or release energy depending on the rotation of the shaft relative to the gear. Further still different folds or angle shapes can be used towards the upper ring to those towards the inner ring and this means the tines can release energy in different rotational directions of the gear and the shaft.

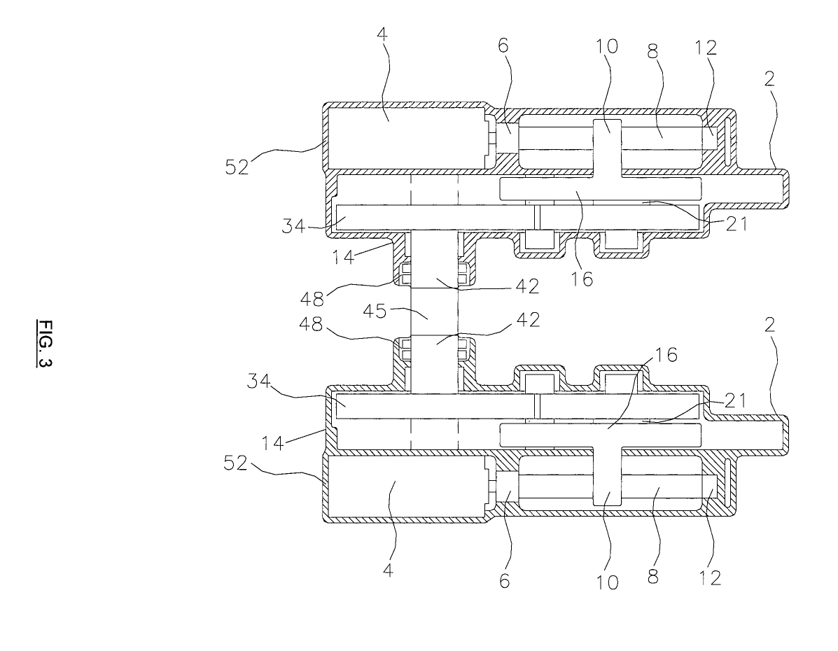

FIG. 3 shows a collective where two gearboxes 52 according to the first embodiment of the invention are coupled to each other. In this case the gearboxes 52 are coupled by the shaft 42 and/or other output means to form a collective output means 45. Each gearbox can work independently, although typically the gearboxes work together. The gearboxes can share the same housing 14 or can have separate housings 14. The gearboxes 52 can work harmoniously together even if the gearboxes 52 are not the same.

Each gearbox 52 can have a different output means not only in terms of force and motion but also with regards to the size and shape. The gearboxes 52 can be attached to each other in axial alignment with relation to the output means 42 as shown in FIG. 3, or may be coupled in a non-axially aligned manner, or at an angle to each other.

As with all the gearboxes, the output means 45 can feature different shapes and/or formats at any point along its length. For example this could be hexagonal or oval. The output means can also carry electrical means for coupling data and/or electrical power between the devices. This electrical connection can also be used to confirm that the gearboxes are connected together.

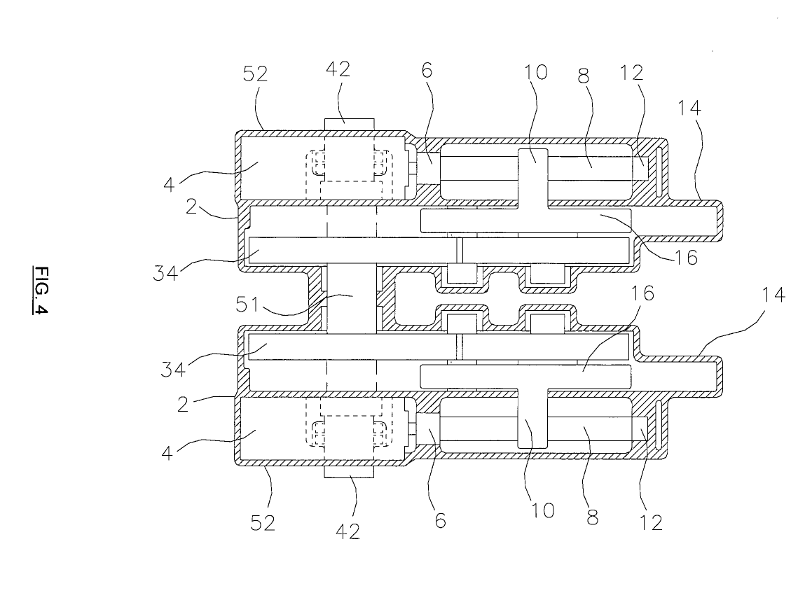

FIG. 4 shows a different collective configuration of gearbox 52. This collective can have all the same functions, features and capabilities as the collective in FIG. 3, however in this configuration the gearboxes 52 are placed back to back with the shafts 42 attached about the section 51.

As with the arrangement shown in FIG. 3, the gearboxes 52 of FIG. 4 may be coupled in an axially aligned or offset manner, and are able to communicate with each other as required.

The output means 42 from one gearbox can be independent or independently movable to that of another gearbox 52, and in the case of the latter the output means 42 can be movably attached. If the gearboxes 52 are to work individually they can have separate output means 42 which are not joined to section 51. Where the output means 42 are arranged to work independently whilst attached, this can be achieved using a captivated bearing. In this form the output means 42 of the gearboxes 52 would be used in a manner that allows them to rotate differently, at different motions and forces in different directions and in either axially or non-axially aligned. For example, the output means 42 can be joined and thus the movement is a summation of both actuators and drive trains and if joined they can be attached at the centre 51.

It will be appreciated that other types of gearbox 2, 52 can be used in the application. It is preferred that any gearbox 2, 52 utilised is self-locking in whatever form.

The self-locking maybe shown as a function of rotational force applied to the output shaft whereby the output shaft will not rotate yet the actuator that provides rotation to the output shaft via the actuator element and/or drive train element will not provide any or any substantial force or motion to the drive train or actuator elements.

The self-locking maybe shown as a function of the force is applied to the output shaft whereby the output shaft does not rotate yet the gearbox does not consume any or any significant power (electrical or otherwise) in order that the output shaft does not rotate. In all cases the gearbox output shaft will rotate in both clockwise and/or anti-clockwise directions.

It is preferred that any other type of gearbox may include energy storage means arranged to store energy during at least part of the rotation of the output shaft to be released during another part of the rotation of the shaft.

The energy storage means may be in the form of a spring. For example, the energy storage means may store energy when the shaft is rotated in one direction, which is released when the shaft is rotated in the opposite direction to assist the rotation of the shaft in the opposite direction.

The gearbox would be such that it allows the application of a force/motion on any linearly moving components or assembly and/or any rotational component or assembly such as a gear and/or a shaft such that the amount of power consumed by the actuator(s) of the gearbox to rotate the output shaft in at least one direction is reduced by comparison to the if force/motion had not been applied. The force/motion can be from a spring or energy storage means.

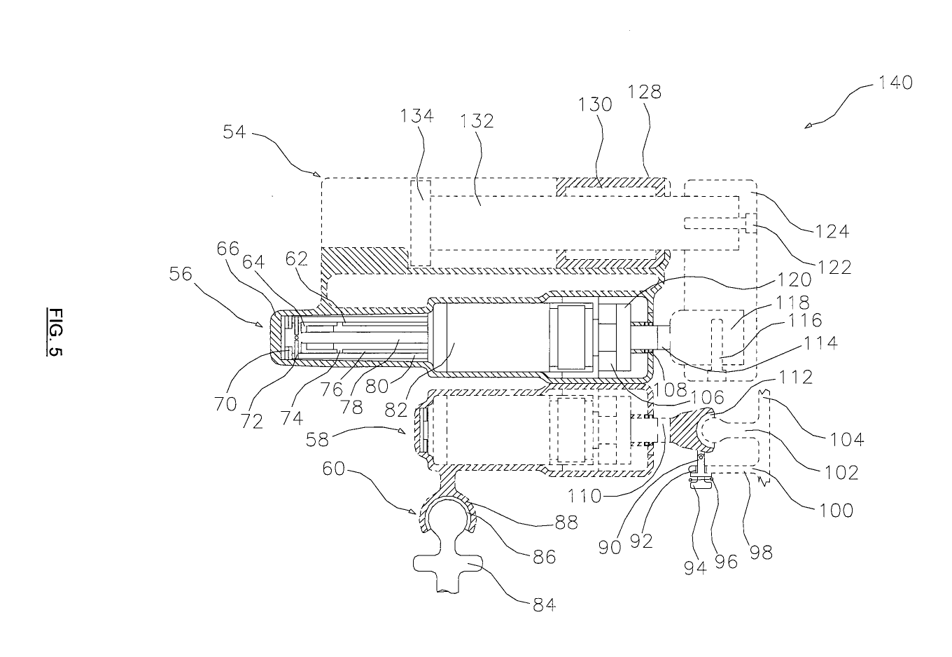

FIG. 5 shows a linear actuator 140 which is able to include any one of the four sections 54, 56, 58 and 60 individually and or collectively in any combination. Each will be described herein with the preferred combinations given reference. However, it will be appreciated that any manner of combinations are possible depending on the application.

The linear actuator 56 includes an externally threaded leadscrew 78 rotatably mounted for rotation about its longitudinal axis. The leadscrew 78 is received within a generally axial bore of a drive rod 114. The bore of the drive rod 114 has an internal thread that threadingly receives the external thread of the leadscrew 78. In use, the relative rotation of the leadscrew 78 with respect to the drive rod 114 causes the relative longitudinal movement between the leadscrew 78 and drive rod 114 to extend and retract the linear actuator.

The drive rod 114 is surrounded by and supported by a sheath 62. The sheath closely fits around the outside of the drive rod thereby preventing lateral movement of the drive rod within the linear actuator. However, the drive rod 114 may move axially within the sheath 62. The sheath 62 may include a low friction surface or coating to assist with the smooth and easy movement of the drive rod 114 within the sheath 62. Seals and/or bearings 108 are shown near the exit point of the sheath 62 to ensure the smooth movement of the drive rod 114 within the sheath 62 whilst preventing contamination passing into or out from the linear actuator.

As shown in 56, the drive rod 114 includes at least one projection 74 extending from the outer surface of the drive rod 114. The projection is received in an elongate channel 76 provided in the sheath 62. It will be appreciated that the channel 76 may be a slot formed through the sheath, a groove provided part way through the side wall of the sheath, or could be defined by projections on either side of a defined channel. The engagement of the projection 74 within the elongate channel 76 prevents the rotation of the leadscrew 78 within the sheath 62, whilst allowing the axial movement of the drive rod 114 within the sheath 62 by allowing the projection 74 to slide along the channel 76. It will be appreciated that any number of projections 74 and corresponding channels 76 may be provided, and that the elongate channel could instead be provided on the drive rod 114 with the projection being provided on the sheath 62. The drive rod 114 typically has a circular cross-section, but could have any other desired shape.

As will be appreciated, the rotation of the leadscrew 78 about its longitudinal axis, and the prevention of the rotation of the drive rod 114, will result in relative rotational movement between the leadscrew 78 and drive rod 114, causing relative longitudinal movement between the leadscrew 78 and the drive rod 114, causing the drive rod 114 to extend from or be retracted into the linear actuator.

As also shown in 56, the sheath 62 may extend beyond of the end of the drive rod 114 in its retracted position, and may include projections 64 which engage with the end of the leadscrew 78 to help avoid lateral movement of the internal end of the leadscrew 78. It would be appreciated that the projections 64 may bear directly against the leadscrew 78 or may include additional bearing components to ensure the smooth rotation of the leadscrew 78.

A generally tubular gear column 80 is shown provided around the sheath 62. An internal end of the gear column 80 is connected to the leadscrew 78, for example through connection pins or arms 72. It will be appreciated that the leadscrew 78 could be formed integrally with the gear column 80. The rotation of the gear column 80 about its longitudinal axis will therefore in part rotational movement to the leadscrew 78 through the connection 72. Suitable bearings 70 may be provided on the end of the gear column 80 and or leadscrew 78 to permit the low friction and smooth rotation of the gear column 80 and leadscrew 78. The bearing may be sandwiched between the internal end of the gear column 80 and leadscrew 78, for example the collar at the end of the leadscrew 78 and a rear 66 of a casing 10 containing the linear actuator.

The gear column 80 also includes a gear 106 that meshes with a drive gear 120 that is in turn driven by a drive 82 such as an electric motor. In this way, the actuation of the drive 82 will drive the drive gear 120, the drive of which will be transmitted to the gear column 80 through the gear 106, which will in turn cause rotation of the leadscrew 78 through the connection of the gear column 80 to the leadscrew 78 via the connection 72. As described above, this rotation will cause the drive rod 114 to extend from or be retracted into the linear actuator. It will be appreciated that intermediate gears may be provided between the drive gear 120 and the gear 106 on the gear column 80. It will also be appreciated that whilst the gear 106 and actuator 82 are shown external to the gear column 80, if the gear column has a sufficient internal diameter, the gear 106 and actuator 82 may be provided within the gear column 80 between the sheath 62 and the inside of the gear column 80.

Whilst the gear 106 on the gear column 80 is shown at the bottom of the linear actuator 56, it will be appreciated that the gear 106 could be provided at any position along the length of the linear actuator to engage with the drive gear 120. An advantage of providing the gear 106 in the location shown in 56 is that the gear column 80 extends along the length of the actuator and accordingly helps support and locate the upper components. Further, this assists with the compact design of the linear actuator as providing the gear 106 at one end of the linear actuator gives the area beside the linear actuator throughout the entire length of the linear actuator for inclusion of the driving components such as the drive 82. In particular, a small or large proportionality between the input and output force and motion can be achieved in a non-complex, space efficient manner.

The linear actuator 56 drive rod 114 includes a section that may be shaped similar to that of a wrench in a generally half hexagonal cut out shape. It will be appreciated that other shapes and forms can be used.

The linear actuator 58 is exactly the same as the linear actuator 56 in terms of operation and as such the workings will not be repeated. It is shown that the linear actuator is different in terms of proportion with the linear actuator 58 being smaller than the linear actuator 56.

Like linear actuator 56 the linear actuator 58 may include a shaped section 110 similar to that of a wrench in a generally half hexagonal cut out shape. It will be appreciated that other shapes and forms can be used. It is preferred that at least one linear actuator 58 may include an end section 112 which is attached or integrated with the piston rod 114. The end section 112 has a cup into which a ball with extension portion 102 can seat to allow multi-axes movement of the ball with extension portion 102. The ball and extension portion 102 is attached or integrate with a surface 104 and which also includes a channelled portion 100 with channel 92 which can feature a pivot or thin member section 98 that allows the channel 100 to flex.

It is preferred that the end section 112 features a pivoted armed link 90 which is pivotally attached to the end section 112. The link 90 has an end stop 94 attached or integrated, the link entering and exits the channel such that the end stop is on the opposite side of the portion 100 to the end section 112. Between the portion 100 and the end stop 94 can be a spring element 96. Therefore the surface 104 is able to move in a multi-axes manner being supported and adjustable by the linear actuator 58 which is able to extend and retract and thus alter the position of the surface 104 with relation to the linear actuator.

The surface 104 is able to be retained against the end section 112 and within the cup due to the link 90 and the channelled portion 100. As the surface moves in one axis the link 90 will move respect to the surface and the channel portion pivoting as required. The spring 96 will provide bias between the portion 100 and the end stop 94 and contribute to its smooth operation and account for any angular differential between them.

The surface can move in another axis with the portion 100 rotating around the link 90. It is shown that the pivot connection of the link to the end section 112 is a one axis pin arrangement however it will be appreciated that this can be exchanged for a multi-axes ball and socket type pivot.

In this preferred description the linear actuator features a pivot point 60 which is attached or integrated at the first end with the linear actuator housing with the second end of the pivot 60 attached to a body such that the linear actuator is able to pivot with relation to the body to which the it is attached and typically the pivoting movement is relational to the movement of the surface 104.

In this preferred description two linear actuators 58 of the same or different overall lengths would be attached or integrated by the housing 14. It is preferred that this arrangement would feature a shape hole in the housing 14 to allow permanently or removably attached at the first end to an exit shaft of a gearbox 2,52 such that rotation of the exit shaft of the gearbox resulted in the rotation of the linear actuator arrangement. It is further preferred that the second end of the linear actuator arrangement would be attached permanently or removably to another gearbox 2,52 such that extension of the linear actuators would adjust the relative position of the gearbox exit shafts.

The pivot point 60 can be used independently of the above and which has a first end attached or integrated with a first body and a second end attached of integrated with a second body. A cup 88 is featured with a bearing 86 into which a ball with an extension 84 is seated and which allows multi-axes movement of the bodies relative to each other.

The linear section 54 is a blank actuator with a slideable rod 132 held by the bearing 130 within the mounting brackets 128 which are retained in a housing. The rod has an end stop 134 to prevent the rod 132 from exceeding its stroke distance. The rod is attached permanently or removably to a body 124 and typically removably with a mechanical fixing 122.

Preferably linear actuator 54 and the linear section 56 are used in conjunction with each other. It is preferred that the linear actuator 56 features an end section 118 by which it is permanently or removably attached to the body 124. Typically the section 118 is removably attached with a mechanical fixing 116.

Preferably as the linear actuator 56 operates and extends the piston rod 114 the rod 132 extends due to the relationship with body 124 and consequently as the piston rod 114 retracts the rod retracts.

It is appreciated that other linear actuators can be used and typically those linear actuators as the linear actuators 56 and 58 above are self-locking such that they are able to maintain a position with or without load to the piston rod 114. Further it may also be that the linear actuators self locking means that the actuator(s) that provide rotation to the leadscrew will not provide any or any substantial force or motion to the leadscrew even if the piston rod is placed under load to maintain the piston rods position. It may be that a load is placed on the piston rod and it maintains its position yet the linear actuator(s) does not consume any or any significant power (electrical or otherwise).

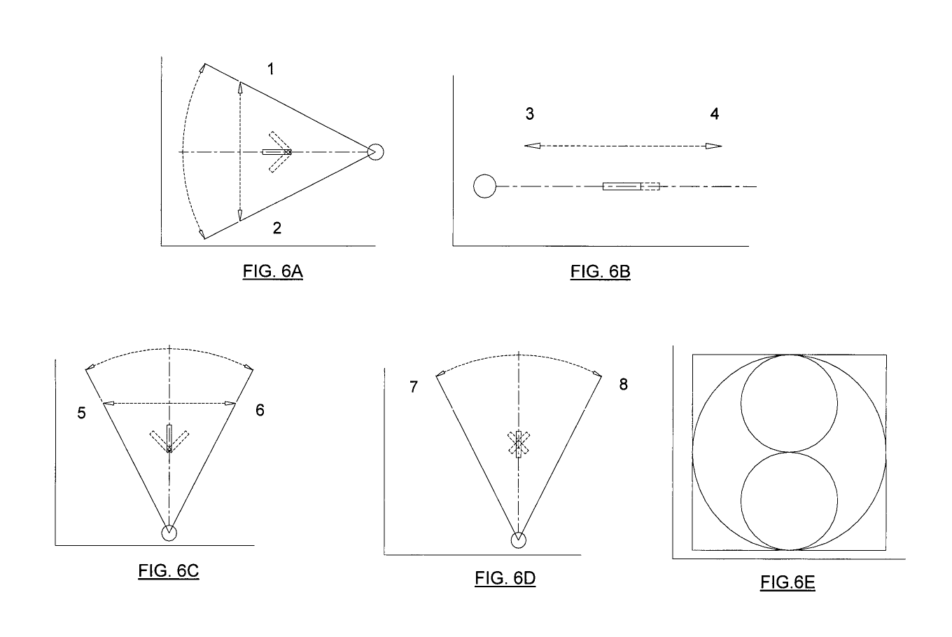

FIG. 6A to FIG. 6E describes the different types of movement which will be applied within the description to comment on the movement of the embodiments. FIG. 6A shows a side view of a body and shows the first and second directions. The movement is shown as an up and down movement about a point where the end result of the body being moved is such to generally form an arc. FIG. 6B is a side view of a body and shows the third and fourth directions. The movement is shown as a linear forward and backwards movement. FIG. 6C shows is a plan view of a body and shows the fourth and fifth directions. The movement is shown as a side to side (left to right) movement about a point where the end of the body being moved such to generally form an arc. FIG. 6D shows a front view of a body moving in the seventh and eight directions. The body is moved generally from side to side about a generally central axis such that the body exhibits a generally twisting movement. FIG. 6E show a front view of the movement patterns a body may achieve with one or more of the movements as described in the FIGS. 6A to 6D.

The movements of the body generally about a point may create any number of general motions. The motions shown in FIG. 6E include circular motions or a figure eight motion or a square motion. Any motion shown can be added to or changed with any combination of further inputs from the movements as referenced in FIGS. 6A to 6D. The movements and motions described in FIG. 6E and any combination thereof with additional inputs from FIGS. 6A to 6D are collectively termed a “helix” motion.

It will be appreciated that a further description to the helix motion can be with regards to a surface such as a surface 104. If we take surface 104 to have at least one point and generally for example will take the surface to have four points where an effective edge equal to the lines between each point can be termed edge one between point one and two, edge two between points two and three, edge three between points three and four and edge four between points four and one.

The helix motion with regards to a surface can be generally described as herein. The edge one may be at a different height to the other at least three edges. Therefore the first point and the second point are level with each other and at a different height to the other at least two points. The first and second points may then become non-level with the second point being generally higher than the first point. As such the second and third points of the second edge are non-level. Edge two can be levelled such that the second and third points are level and edge two is at a different height to the other three edges.

The second and third points may then become non-level with the third point being generally higher than the second point. As such the third and fourth points of edge three are non-level. Edge three can be levelled such that the third and fourth points are level and edge three is at a different height to the other three edges.

The third and fourth points may then become non-level with the fourth point being generally higher than the third point. As such the fourth and first points of edge four are non-level. Edge four can be levelled such that the fourth and first points are level and edge four is at a different height to the other three edges.

The first and fourth points may then become non-level with the first point being generally higher than the fourth point. As such the first and second points of edge one are non-level.

Edge one can be levelled such that the first and second points are level and edge four is at a different height to the other three edges.

Therefore the helix motion can repeat. A feature of the helix motion may also be that the surface is able to exhibit pure vertical lift where the surface is raised or lowered with all four point and edges being level with each other. A feature of the helix motion may also be that the surface is able to exhibit generally vertical lift where the surface is raised or lowered with all four points and edges being generally level with each other.

It will be appreciated that the means to create such a motion can be varied. One such method is the use of at least one linear actuator 58 located such as to allow the helix motion of the surface 104 as seen in FIG. 5. It is preferred that the at least one linear actuator 58 would be pivotally attached to the surface 104. Generally at least one linear actuator 58 would be positioned generally toward each of the at least one points. It is preferred that the at least one linear actuator 58 may also be pivotally attached to a body by the pivot joint 60 also seen in FIG. 5. It is preferred that each linear actuator 58 pivots relative to the extension and/or retraction of the all linear actuators 58 end section 112 (including its own) and movement of the surface 104.

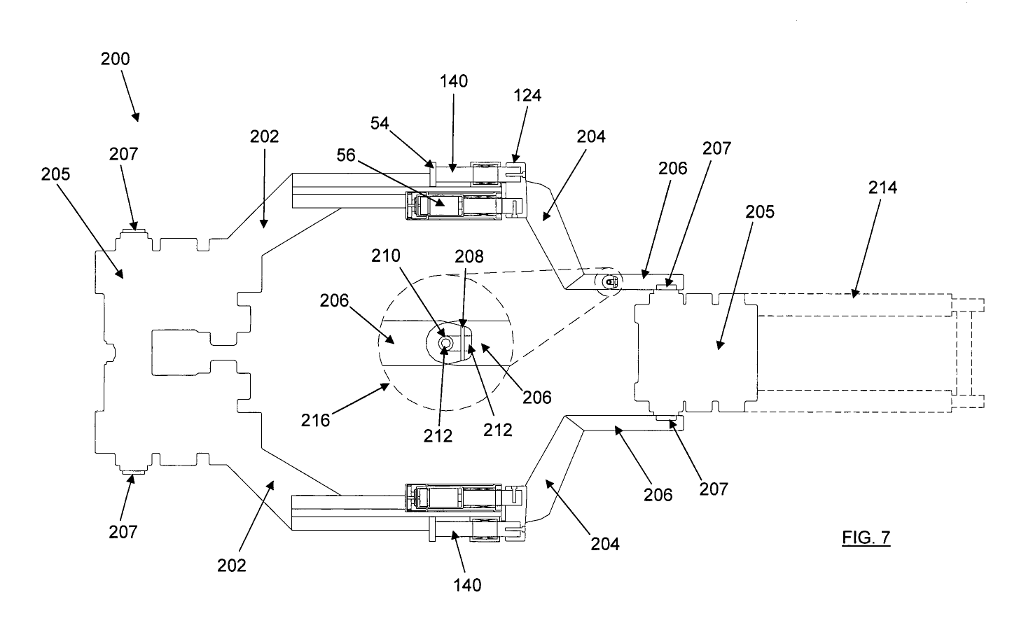

FIG. 7 shows the first embodiment of the linkage 200 which is applicable to multiple fields. The linkage has functions and features which have been described previously and as such will not be repeated. The figure shows a first and second gearbox 205 is able to be the gearbox 2, 52 which has been described in FIGS. 1 to 4 or another such suitable gearbox as also described. The first and second gearbox 205 have at least one exit shaft and may be self-locking. An arrester device is able to be fitted to the gearboxes and this arrester device which in its most basic form will lock the rotation of the exit shaft of a gearbox if the gearbox malfunctions from wear or failure. The arrester would in the event of gearbox malfunction lock the at least one output shaft 207 and thus provide a fail safe feature. The output shaft 207 is able to be shaft 20, 42 or 45 from FIGS. 1 to 4 and most typically but not limited to in this embodiment the 207 will the shafts 42.

Any reference to directions such as the first, second, third, fourth, fifth, sixth seventh, eight directions and/or motion such as the circular, helix and the like are further detailed in FIGS. 6A to 6E.

The first gearbox may be permanently or removably attached to at least one extension 202. As shown the first gearbox is attached to two extensions located at each side of the gearbox. The extensions include at least one linear actuator 140. The linear actuators have been described previously and purely for reference it is indicated that the linear actuator features section 54 and 56.

The block 124 to which the linear actuators are attached is itself permanently or removably attached or integrated with the section 204. It is preferred that the section 204 is attached or integrated with the section 206. The section 206 attaches the exit shaft of the second gearbox 205. The section 206 can feature a pivot 216. The pivot is able to be fitted between the sections 204 and 206. The pivot can be pivot 60 as discussed in FIG. 5 where the first end of the pivot 60 is attached to the section 204 and the second end to 206. Conversely the first end of the pivot may be attached to the section 206 and the second end to the exit shaft 42 of the second gearbox.

The second gearbox may have extensions 214 permanently or removably attached. The second gearbox may instead have the extension 204 with the linear actuators 140 and section 206 permanently or removably attached as described above.

The pivot section 216 consist of a shaft 212 and a bearing 210 which are removably or permanently attached or integrated with the second portion of the section 206. The first portion of the section 206 or the section 204 has a slot and as such can be pivotally engaged with the shaft and bearing. The captivation block 212 is placed into the slot towards the second portion of section 206. At least one pin is then placed through the first section 206 first side, through the block and into the first section 206 second side. This retains the assembly and allows an axis of rotation. Several pivots can be used which each allowing rotation in a different axis.

The first gearbox exit shafts can be attached to a body sufficient that they are held stationary. As the first gearbox induces rotation, the first gearbox will rotate about the axis of its exit shaft and thus cause movement of the linear actuators and the second gearbox in the first and second direction depending on rotational direction of the output of the drive train and/or actuator element.

The linear actuators 140 are able to extend and retract and are arranged such that the actuation of the at least one linear actuator adjusts the relative position of the first and second driven shafts. Therefore as the linear actuator drives forward the piston rod the block 124 is extended (moved in the fourth direction) and as such the section 204 and 206 are also moved in the fourth direction and thus the relative position of the driven shafts of the first and second gearbox are adjusted. It will be appreciated that the reverse occurs when the linear actuator retracts (moves in the third direction).

The linkage in this embodiment may have only one extension arm attached to the first gearbox with one linear actuator and no pivots. As the above, the extension and retraction of the linear actuator will result in the second gearbox and its subsequent output shaft moving in the third and fourth direction as per FIG. 6A.

Similarly the first gearbox may feature two extensions as shown with only one extension having a linear actuator 140 but the at least one section 206 including at least one pivot 216. If only one section 206 has just one pivot 216 then as the linear actuator extends some movement of the second gearbox and subsequently the shaft will occur about the pivot shaft axis in the fifth or six directions depending on which side the linear actuator is located relative to the pivot 216, however this movement will be limited and relative to the flexure of the materials in the extensions and other arm sections such as 206 and 204.

Similarly the first gearbox may feature two extensions as shown with a linear actuator 140 within each extension and each section 206 featuring at least one pivot 216. Where one pivot 216 is featured the simultaneous extension of the linear actuators in each extension as described will move the second gearbox and subsequently its exit shaft in the fourth direction where the retraction of the linear actuators will move the second gearbox and said output shaft in the third direction.

However, the linear actuators in each extension are able to move independently and with each section 206 including at least one pivot the extension of the first linear actuator only will result in the second gearbox pivoting about the axis of the shaft of the first pivot 216 in the opposite section. Consequently if the extension of the second linear actuator occurs whilst the first linear actuator remains in stationary and in the extended position the second gearbox will be rotated about the axis of the shaft of the second pivot 216 in the opposite section.

In this manner the exit shaft of the second gearbox can be returned to having both exit shafts in the same vertical plane or the second linear actuator can keep extending to and rotate the second gearbox further around the axis of the first pivot.

It can also be appreciated that each linear actuator can extend and retract independently and as such if the first linear actuator as described above where to retract, the second gearbox and subsequent shaft would pivot about the axis of the second pivot at the same side as the first linear actuator regardless of the extension or retraction of the second linear actuator. Therefore each linear actuator independently extending or retracting can move the second gearbox and subsequent output shaft in the fourth and fifth direction.

Furthermore the movement of the second gearbox and subsequent output shaft in the fourth or fifth direction can occur at the same time as the movement of the said gearbox and output shaft in the third or fourth direction. The linear actuators are able to be controlled independently and operate at the same or different speeds of extension and retraction. Therefore if both linear actuators simultaneously extend at the same rate of extension the shaft of the second gearbox remains in the same vertical plane. However still with both linear actuators extending, the first linear actuator extends at a faster rate the gearbox will continue to move in the fourth direction at the same time as pivoting about the second pivot point and moving in the fifth or sixth direction.

Therefore it can be appreciated that one actuator is able to able to move the second gearbox and its subsequent output shaft in both the fifth and sixth directions provided each section 206 has at least one pivot and without using the flexure of the material.

The second gearbox at least one exit shafts can be attached to the least one section 206 sufficient that they are held stationary. As the second gearbox induces rotation, the second gearbox will rotate about the axis of its exit shaft in the first and second direction depending on rotational direction of the output of the drive train and/or actuator element.

Any combination of the directions can be achieved and it will further be appreciated that different combinations of the assemblies and/or components can be used to achieve those directions.

It can also be appreciated the first and second gearboxes can rotate independently or simultaneously at the same or different angular velocities. Preferably the gearboxes like the linear actuators are self locking, therefore each can be operated as described above and there relative position can be maintained. Thus is advantageous as when the gearbox and/or the linear actuators are moved to a position that position can be held even if load is applied. It has further advantage as preferably the gearboxes and linear actuators are able to self lock such that no power is required to maintain there position even under load.

For example, a load could be attached to the second gearbox and where the first gearbox rotates and consequently rotates the second gearbox and the load about the axis of the first gearbox output shafts in the first or second direction. When power is stop to the first gearbox the second gearbox and thus the load will remain in the position at which the power was removed as the gearbox is self locking and thus provides a secure and stationary fixture for the second gearbox. The same is true of the second gearbox in that it can rotate about the axis of its exit shafts and further rotate the load in the first and second direction.

When power is removed from the second gearbox the load will remain stationary with no power being consumed to keep it stationary by the first or second gearbox. The linear actuators are free to move as described above and like the gearboxes they can extend to lift the load and once power is removed from the linear actuators the load will remain in place with no further power being consumed by the linear actuators to keep the load stationary. The movements of the linear actuators and the gearboxes are non-sequential in that they are able to move independently irrespective of the other gearboxes and/or linear actuators within the linkage.

The self locking nature of the gearboxes and the linear actuators means that the linkage is self framing in that the linkage does not require a further frame structure and its layout provides its own structure.

The non-sequential nature of the gearboxes and the linear actuators also is advantageous with regards to the linkage being self framing as no other structures are required in order to mount other components or assemblies required for movement.

It is preferred that the linkage gearboxes have at least one energy storage element as described above. Therefore as the above example, when the second and first gearbox lower the load, energy resultant from the load's weight can be stored in the gearboxes to be released when lifting the same or another load in this way the overall power consumption of the gearboxes for a given load is reduced. The linear actuators can also feature energy storage elements that act in a similar manner.

The linear actuators via sensors may be able to sense load bias and the tilt of the linkage such as the linkage is on uneven or inclined ground. The linkage sensors are able to identify the load becoming biased to one side or the other for example the movement of the load or a gust of wind and/or the relative orientation of the linkage to the ground. If the load becomes biased to one side or the other (like a pendulum motion) the at least one linear actuator can extended or retract to move the second gearbox in the fifth or sixth direction to correct and/or neutralise or generally minimise the load and/or ground bias.

The linkage is double ended in that the second gearbox can be attached to a body as shown with the connection 214. All the same aspect apply in terms of the at least one linear actuators 140 yet the relationships are reversed. It will be appreciated by someone skilled in the art in terms of the difference and will not be described in detail.

The exit shaft of the second gearbox will rotate the sections 206, 204, the linear actuators and subsequently the first gearbox about its exit shaft axis in the first and second directions. The linear actuators movements will be the same in terms yet instead of moving the second gearbox they will move the first gearbox in the third and fourth direction and/or the fifth and sixth direction as above. This reversal allows a device to attach to the exit shafts of the first gearbox such that the first gearbox rotation causes the attached device to rotate in the first and second direction.

The linkage may act as a suspension device or tensioning device the energy elements can be employed to set and maintain a tension relative to usage. By way of example and taking the linkage to be attached to act as a tension device where the first gearbox can be attached via the exit shaft to a member whilst the second gearbox is engaged with a belt or chain or other such item that requires constant and variable tension.

The gearbox 205 which can be gearbox 2, 52 in FIGS. 1 to 4 and thus contain at least one energy element with tines 26 and an inner ring 18 and an outer ring 28. The energy element is able to be attached as described to the gear 34 where the gear 34 can be rotationally engaged with the shaft via a bearing and the shaft which is the output shaft is also rotatable mounted in the housing.

The gearbox via the actuators elements can rotate the gear 34 and as such place a predetermined tension in the spring with relative to a load. For a given load the shaft will in one direction resist rotation of the output shaft and in the opposite direction of rotation it will add to the rotation of the shaft. This is the same for both the first and second gearboxes.

The first gearbox attached to the member via the shaft whilst the second gearbox is placed against the chain or conveyor or other tension requiring application. The second gearbox may have external wheels or other roller type elements fitted in the region of contact with the chain or conveyor application such as the contact of the second gearbox with the system is via the wheels or rollers.

The second gearbox is rotated and orientated in the correct manner whilst the linear actuators may extend or retract to further position the second gearbox relative to the first and the application. Each gearbox is then operated such that the tension on the shaft from the energy element is increased or reduced.

Therefore as the tension in the application decreases the tension in the energy element will rotate the second gearbox clockwise or anti-clockwise depending on application and as such keeping the correct tension in the application. This is also true of the first gearbox, the tension reduce or increase will have the same effect in the first gearbox such the tension in the energy element will either means the shaft rotates clockwise or anti clockwise depending on the application and the operation of the second gearbox.

The linkage will therefore tension the application, if further tension of or less tension is required either the tension in the energy element can be reduced or in increase via further rotation of the gearbox drive train and/or actuator element. The linear actuators are also able to be extended and retracted.

This suspension type application for the linkage is also applicable to other applications such as chassis for any type of mobile application from prams to cars or trucks.

Both the extensions 202 and the other sections 204 and 206 may feature different or the same properties and may be rigid or flexible. The flexibility is in at least one axis and allows the extensions and sections to twist and/or bend around the longitudinal and vertical axes. The nature of the flexure is able to be designed to manifest in just one axis whilst the extensions and/or section remain rigid in another and this can be achieved via the use of materials such as carbon fibre. The flexure allows the extensions and sections to correct within limits a biased load as the extensions and section are able to flex and effectively level the load and even that load across both output shafts of the gearbox.

The flexure allows the gearbox exit shafts the section 206 in particular to remain correctly aligned with each other and ensures that for example the exit shaft of the gearbox does not receive an excessive turning moment respective to its axis and generally perpendicular to the at least one extension.

The extensions 202 and sections 206 and 204 may be removably attached to the gearbox or each other and all may be removed and replaced with other extensions and section with different characteristics such as flexure axes, characteristics and length.

The extensions and sections carry at least one electrical element 3 which is able to contain at least one sensor whereby the relative flexure of the at least one extension and/or section can be monitored and if they exceed a set limit the power to the gearbox is cut and thus the linkage 200 stops rotating and is held in its relative position.

The extensions and section can include at least one LED; display screen and/or display touchscreen where the electrical element 3 can display various information such as different colour LEDs for different load limits and visual writing on the screen.

Through the electrical element 3 the devices are wireless and are able to sense via wireless communications the presence of another linkage 200 or devices. The electrical element 3 will illuminate the end to which the other device or linkage 200 is to be attached and if the other linkage 2000 or device is a different load limit the lowest load limit of the two will be shown with relation to the screen and/or the LEDs.

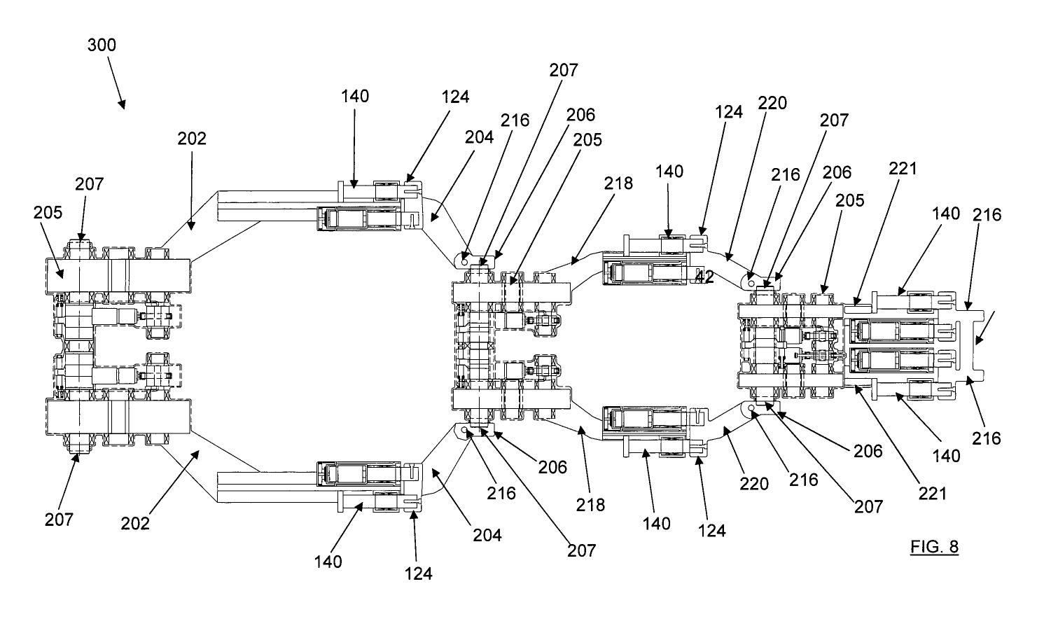

FIG. 8 shows variation of the first embodiment linkage 300. Linkage 300 can have all the same functions and features as linkage 200. Where the components or assemblies are the same they will not be described again in detail. However and in particular the first, second and third gearboxes and all the linear actuators may all be self locking and include energy elements that can store energy and release energy as described above. It will also be appreciated that the linkage 300 and all its gearboxes can exhibit the tensioning capabilities as described with relation to the linkage 200.

Any reference to directions such as the first, second, third, fourth, fifth, sixth seventh, eight directions and/or motion such as the circular, helix and the like are further detailed in FIGS. 6A to 6E.

The linkage 300 as shown has a gearbox 205 as above with two exit shafts 207 whereby the a first and second gearbox 205 is able to the gearbox 2, 52 which has been described in FIGS. 1 to 4 or another such suitable gearbox as also described. The at least one output shaft 207 is able to be shaft 20, 42 or 45 from FIGS. 1 to 4 and most typically but not limited to in this embodiment the 207 will the shafts 42.

The first gearbox is attached to or integrated with the extensions 202 which include at least one linear actuator 140. The linear actuators 140 are attached to the blocks 124 which is attached or integrated with the sections 202. The sections 202 are pivotally attached to the sections 206 by the pivots 216. It will be appreciated that the pivots are able to be the pivot 60 as described in FIG. 5.

It will also be appreciated that as with linkage 200 the pivot 60 can be attached to between section 206 and the exit shaft of the second gearbox. The section 206 is attached to the exit shafts 42 of the second gearbox. The second gearbox has extensions 218 which can have all the same features and functions as the extensions 202. The extensions 218 feature linear actuators 140 which are attached to the block 124. The block 124 can be attached or integrated to the sections 220 where the sections 220 can have all the same features and functions as the sections 204.

The sections 220 are pivotally attached to the section 206 by the pivots 216. It will be appreciated that the pivots are able to be the pivot 60 as described in FIG. 5. It will also be appreciated that as with linkage 200 the pivot 60 can be attached to between section 206 and the exit shafts 42 of the third gearbox.

The third gearbox is attached or integrated to the sections 221 which include the linear actuators 140 whereby the linear actuators are attached to the section 223 in the same manner as they are attached to the block 124. The attached is a removable attached made with mechanical fixings as described in FIG. 5.

As with the previous embodiment the first gearbox can be attached to a body via the exit shafts where the rotation of its drive trains and/or actuator element providing the shaft is sufficiently held the gearbox will rotate about the axis of the shaft. The first gearboxes rotation will rotate the second and third gearboxes and associated components and assemblies as described the first and second direction.

The first gearbox is attached to the sections 206 via the exit shafts where the rotation of its drive trains and/or actuator element providing the shaft is sufficiently held the gearbox will rotate about the axis of the shaft. The second gearbox's rotation will rotate all associated assemblies and components of the second gearbox as described and the third gearbox and associated components in the first and second direction.

The third gearbox is attached to the sections 206 via the exit shafts where the rotation of its drive trains and/or actuator element providing the shaft is sufficiently held the gearbox will rotate about the axis of the shaft. The third gearbox's rotation will rotate all associated assemblies and components of the third gearbox as described.

The first, second and third gearboxes can rotates in the same or different directions simultaneously and all the gearboxes can rotate independently. The first, second and third gearbox can rotate at the same or different angular velocities.

The linear actuators between the first and second gearbox can as the linkage 200 extend and retract at the same or different speeds simultaneously or independently. The movement of the linear actuators independently or simultaneously can move the second gearbox and subsequent exit shaft and associated assemblies and components in the third or fourth direction as well as the fifth and sixth direction. As the second gearbox moves then the third gearbox and all its associated assemblies and components move in the same direction.

The linear actuators and associated components between the second and third gearbox have all the same functions and features and the movements have been well described. The linear actuators are able to move independently or simultaneously at the same or different speeds and in the same or different directions. Where the linear actuators move at the same speed and in the same direction the third gearbox will move in the third and fourth direction and where the linear actuators move in direction directions, move independently or move at different speeds in the same direction the third gearbox will rotate about the pivots 216. The linear actuators are able to move the third gearbox simultaneously or independently in the third and fourth and the fifth and sixth directions.

The linear actuators and associated components of the third gearbox have all the same functions and features and the movements have been well described. The linear actuators are able to move independently or simultaneously at the same or different speeds and in the same or different directions. Where the linear actuators move at the same speed and in the same direction the components 223 will move in the third and fourth direction and where the linear actuators move in direction directions, move independently or move at different speeds in the same direction the member 223 will pivot about the pivots 216. The linear actuators are able to move the member 223 simultaneously or independently in the third and fourth and the fifth and sixth directions.

All the linear actuators in the linkage can move independently or simultaneously at the same or different speeds and in the same or different directions. Therefore a snake like movement can be achieved along the length of the linkage with at least two effective sections (a gearbox and associated assemblies and components) being in the fifth or sixth direction opposite to the remaining effective section. During all the linear actuator movements the gearboxes are able to rotate there effective section simultaneously or independently at the same or different angular velocity and in the same or different directions.

This allows extreme functionality and accuracy, the linear actuators are able to provide movement and load biasing as has been described. One advantage of this movement is in medical robots and in particular surgical robots where extreme accuracy is required.

Further applications include car manufacturing where the biasing allows for a degree of flex in the extensions and sections meaning that the robots can be lower weight and/or are able to move faster and have increased accuracy and are able to reduce power consumption.

The biasing allows rapid acceleration or deceleration whilst the linear actuators via the sensors actively correct any flex in the components relative to the final position. An advantage of this is the extra precise placement of components whilst the linkage is moving allowing “placement on the fly”. This saves time per operation which although relatively small over repeating processes the time saving and increased accuracy is highly advantageous.

The biasing as stated also assists the linkage or robot to account for temperature effects where components and assemblies expand and contract at different rates. Therefore the linkage can continually assess itself and make adjustments via the linear actuators. As such the linkage will perform to the same accuracy in a cold environment as a hot environment. This can save overall power consumption as buildings in which the linkages can be used would not have to be kept within a temperature margin and the devices can be taken from the outside to the inside where large differences in temperature may exist.

The blank piston within the linear actuator 140 and referenced as 54 from FIG. 5 may also feature an energy adsorption element such as a mechanical spring or it could be fluid type cylinder element.

The blank piston 132 can slide backwards the forwards with the actuator piston rod 114 and as such provide additional support. However the unit 56 is able to take out or reduce unwanted movement such as vibration or flexure from the linkage in the first, second, third, fourth, fifth, sixth, seventh and eight directions. This can be achieved with energy elements located with regards to the blank rod 132 and typically a mechanism type spring would be situated between the case 128 and end stop 134.

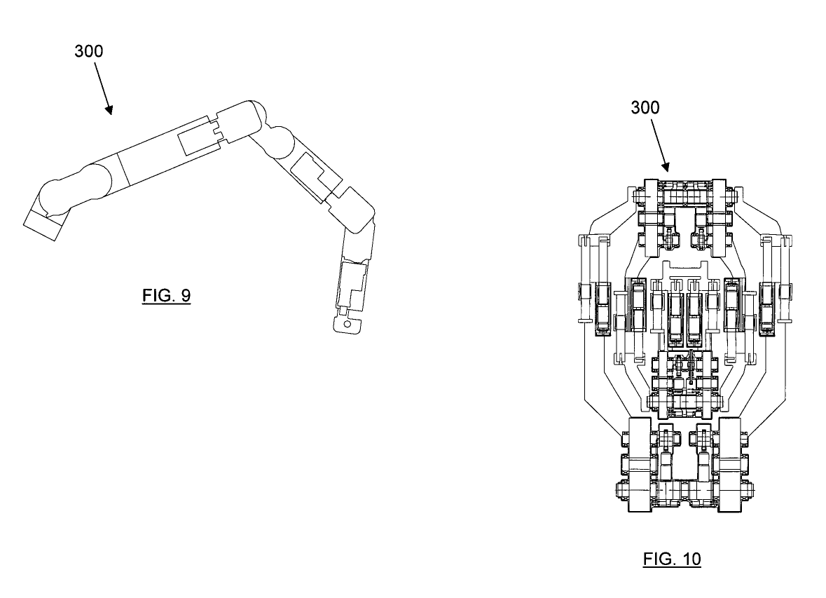

FIG. 9 shows the linkage 300 in side profile whereby each effective section is rotated independently about the gearbox exit shafts. The linkage or chain is able to be fitted with or without linear actuators. The chain can be formed into many different shapes and is able to be moved in a snake like fashion with no requirement for cables and/or other such random flexible elements. The mechanical nature of the linkage provides a stable platform that is able to also store energy as well as deploy energy and work as a tensioning system. The energy storage and release assists with the reduction of the linkage power consumption against a given load. The linkage can also reduce vibration, flexure and other unwanted movements and dampen sudden load biasing and/or biasing resultant from a load.

Like the linkage 200 the linkage 300 is able to operate whilst being attached at the opposite end to that described. As such the linkage 300 may be held relative to the bar 223 and in this case the rotation of the exit shaft of the third gearbox will rotate the second and first gearboxes and associated components/assemblies about its axis. The rotate of the second gearbox exit shafts will rotate the first gearbox and associated components/assemblies. In this case the relative movements of the linear actuators will be the same but reversed.

FIG. 10 shows the linkage 300 a fully folded manner. Shown here the effective third section (the third gearbox and associated components and assemblies) has folded into the effective second section (the second gearbox and associated components and assemblies) with the effective second and third sections having folded into the effective first section (the first gearbox and associated components and assemblies). The linear actuators can operate as described above even when folded as can the gearboxes.

The folding is highly advantageous not only allowing the unit to be stored easily but also meaning that any effective sections that are not required for an application but might be present in the linkage can be folded away whilst other effective sections are used. This allows the linkage to be tailored to its environment and application. As an example, in one application the reach of the linkage may require all three effective sections, but in another application only one effective section might be required. As such the two linkages can be folded.

It is also an advantage that the linkage does not require any form of pre or post calibration to deploy or fold. The linkage can continuously self assess and/or correct itself described above with such means as sensors and/or springs and the like. The gearboxes are and as such the effective sections can simply be moved as described or it can be operated without any sensors This ability to not require any pre or post calibration means it is instantly able to be used in any format and a major step forward in the sector.

Furthermore in semi folded state or where a effective third section is rotated and as such is not in the same plane effective second section to which it is attached, movement of the linear actuators in the effective second section will produce movement in the seventh and eight direction referenced in FIG. 6 in the effective third section. This movement is a twist movement about a central axis of the effective third section which means that the effective third section can achieve four axes of movement relative to the axis by which it is attached to the at least one effective section.

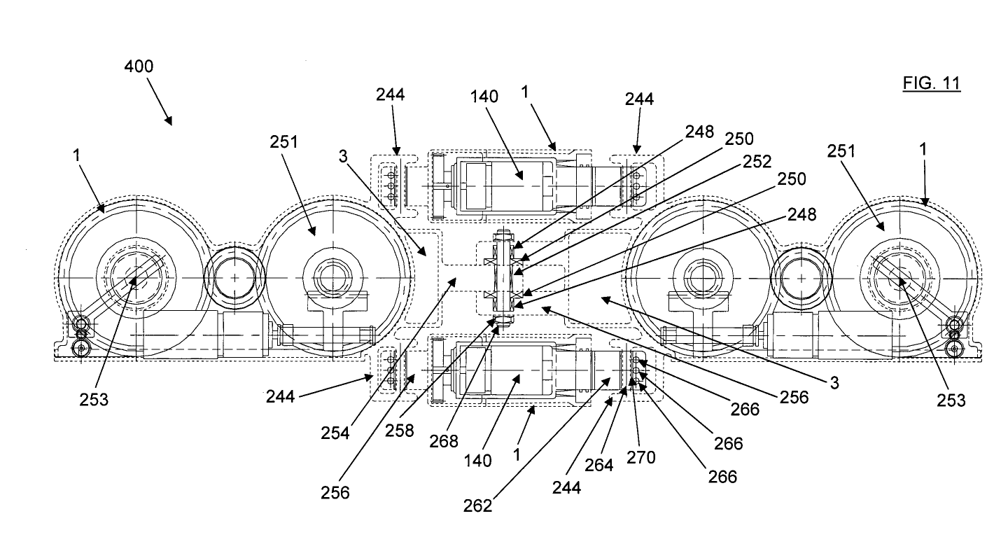

FIG. 11 shows the second embodiment of the linkage. Linkage 400 is able to have all the relevant functions and features of the linkages described above. The unit 400 has at least one gearbox 251 and at least one linear actuator 140. The gearbox 251 is able to be the gearbox 2, 52 which has been described in FIGS. 1 to 4 or another such suitable gearbox as also described. The gearbox has at least one exit shaft 253 is able to be shaft 20, 42 or 45 from FIGS. 1 to 4.

Any reference to directions such as the first, second, third, fourth, fifth, sixth seventh, eight directions and/or motion such as the circular, helix and the like are further detailed in FIGS. 6A to 6E.

Illustrated here the unit 400 has at least one gearbox 251 which is connected in a rotational manner to at least one other gearbox 251. The first gearbox 251 has a casing 1 which can house at least one pivot element 244 and generally the pivots 244 are located towards the upper and/or lower part of the casing 1. The pivot 244 have at least one axis of rotation and allows the at least one gearbox 251 to be pivotally connected a linear actuator 140. The linear actuator 140 is further connected to the second gearbox 251 via another pivot 244. The pivot 244 can allow electrical data and/or power to be sent and/or received therefore the first and second gearbox 251 can send and receive electrical power and/or data to each other and/or the linear actuator 140. The linear actuator 140 is attached or integrated with the casing 1 of the first and second gearbox 251.

The figure illustrates a first and second gearbox 251 with two pivotally connected linear actuators 140. The first and second gearboxes 251 are further pivotally connected. The pivot means connecting the first and second gearbox 251 consists of an extension portion 254 to the first gearbox and an extension 256 to the second gearbox whereby each extension features an electrical element 3 which allows power and data to be sent and received by each gearbox from the other.

The extensions 254 and 256 are attached or integrated to the respective casing 1 whereby the extension 256 has two sub portions 266. The extensions are connected rotationally. The extensions 254 and 256 are connected via an assembly which includes a shaft 268 held in placed via screw nuts 258 located at both end of the shaft 268. Several bearings are used with the at least one bearing 248 and 250 held within the extension portion 266. They allow free rotation of the shaft 212 and the low friction rotation of the extension 254 relative to extension 256 and therefore low friction movement of the first and second gearboxes in fifth and sixth direction as per FIG. 6C. A further bearing 252 is placed in extension 254 to ensure its location with respect to the shaft 268 is a low friction engagement.

The pivot 244 is attached or integrated to the casing 1 and consists of a shaft 264 which is attached or integrated with the structure of 244. The linear actuator 140 has a rear extension 256 which is attached and/or integrated with the casing 1. The rear extension 256 is attached to the shaft 264 which is in turn attached to the 244 of the first gearbox.

The linear actuator is movably attached to the shaft 264 which is attached to the pivot 244 of the second gearbox via the piston rod 114. The front and rear extension 256 and piston rod 114 are attached in the same manner. The attachment assembly includes a bearing 270 located on the shaft 264 whereby the piston rod 114 or extension 256 is retained in a suitable manner with at least one pin 266.

The linear actuators 140 are located at the first side and/or the second side of the gearbox 251. Shown here the two actuators are at the first side of the linkage whereby as the linear actuator 140 extends (moves in the fourth direction) via the piston rod 114 the gearboxes and therefore the linkage 400 pivot about the axis of the shaft 268 in the fifth direction and as the linear actuators retract the gearboxes and therefore the linkage pivots about the axis of the shaft 268 in the sixth direction and therefore the linkage is able to act in a “wag” like motion.

The linear actuators 140 are able as described to include a blank as per 54 from FIG. 5 and that blank is able to feature a spring or energy absorption or damping element. Energy can be absorbed in the fifth or sixth direction and given back in the respective opposite direction along with the ability to also dampen vibration and/or sudden movement such as a change in load biasing.

As with the previous embodiments the extensions 266, 256 and 266 as well as the pivot 244 are able to feature flexure and thus limited movement is able to take place in the first and second direction via the input of the linear actuators in terms of extending (fourth direction) or retraction (third direction) movement of the piston rods 262. To achieve the limited first and second direction movement the upper or lower actuator would move in one direction such as retract whilst the other linear actuator would either move in the opposite direction or remain stationary. In all cases the linear actuators arranged such that the actuation of the at least one linear actuator adjusts the relative position of the first and second driven shafts.

In both cases the exit shaft 253 of the first and second gearbox is able to be attached to a body which is able to be rotated via operation of the relevant gearbox. The first and second gearboxes are able to rotate the exit shafts in the same or different directions and at the same for different angular velocities. The first and second gearboxes are able to rotate the exit shafts simultaneously or independently.

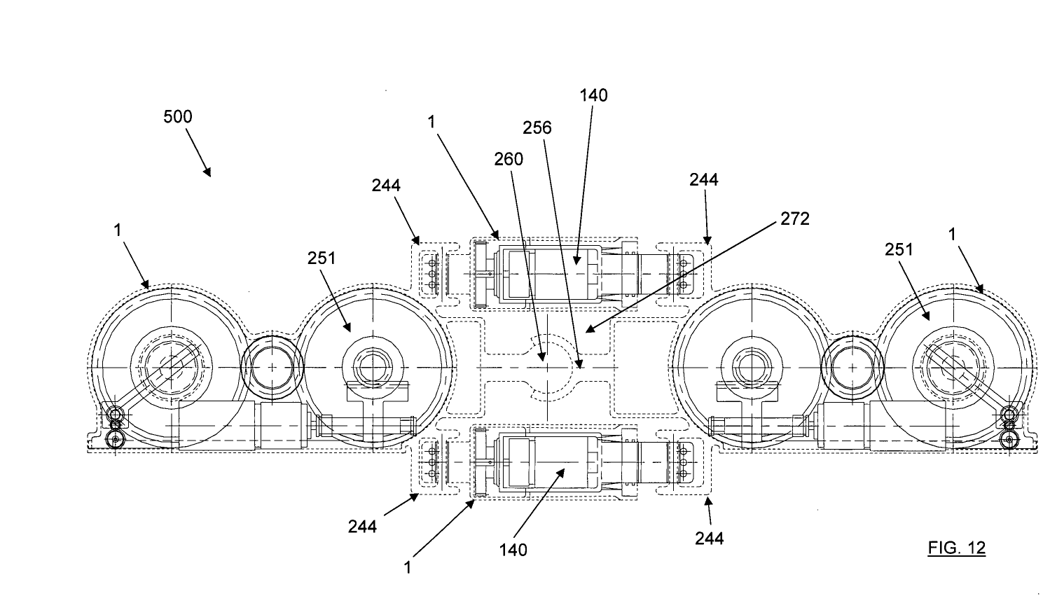

FIG. 12 a variation of the second embodiment linkage 500 which can have all the relevant functions and features as any embodiment herein and where the components or assemblies are the same as those in FIG. 11 no further description will be given. The figure is essentially the same as FIG. 11 with the exception of the pivot 60 which is a ball and socket attached or integrated with the first and second gearbox respectively.

Any reference to directions such as the first, second, third, fourth, fifth, sixth seventh, eight directions and/or motion such as the circular, helix and the like are further detailed in FIGS. 6A to 6E.

The ball and socket elements 60 are able to take the form of extensions 260 and 256. The ball and socket allows movement in the fifth and sixth direction when at least one linear actuator 140 is extended or retracted. With at least two linear actuators as shown the ball and socket means 272 allows the linkage via the movement of at least one gearbox to move in the first and second direction with some flexure in the pivots 244. Any combination of these movements can be used and thus the linkage can produce a limited helix motion whereby at least one gearbox motion about the ball and socket pivot resembles a circular motion or a figure of eight motion.

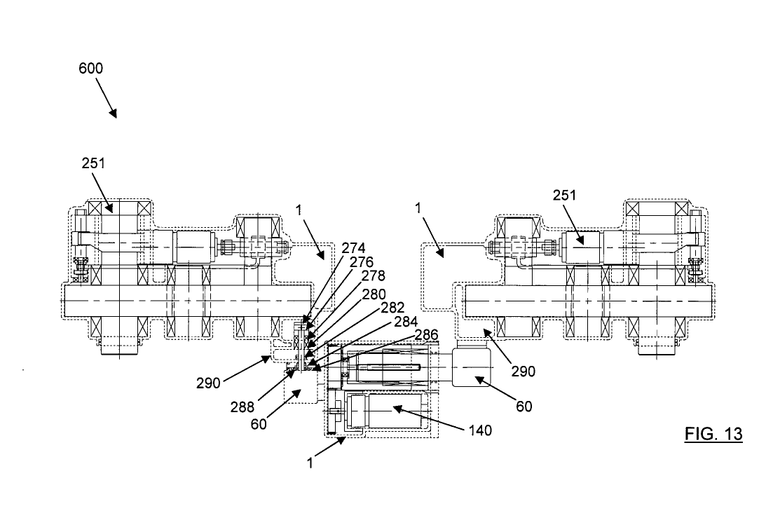

FIG. 13 shows a variation of the second embodiment linkage 600 which can have all the same functions of all previously described embodiments. Where the components or assemblies are the same as those described previously no further description will be given. The pivots 60 can be ball socket pivots as described previously or pivot elements such as those previously described 244.

Any reference to directions such as the first, second, third, fourth, fifth, sixth seventh, eight directions and/or motion such as the circular, helix and the like are further detailed in FIGS. 6A to 6E.

The linkage has a first gearbox 251 of the linkage connected to a second gearbox 251 whereby the gearbox 251 is able to be the gearbox 2, 52 which has been described in FIGS. 1 to 4 or another such suitable gearbox as also described. The first and second gearbox 251 have at least one exit shaft and may be self-locking.

The connection is provided by at least two pivots (the first and second pivots) at each end of the at least one linear actuator 140 which connects the first and second gearbox. The first pivots are located at the end of the at least one linear actuator and are typically multi-axes pivots 60.

The second pivots are attached to the first pivots and attached to the casing 1 and shown with reference 290. These second pivots could also be ball and socket pivots 60. The pivots 290 have an end capped shaft 274. The shaft 274 is attached to the first pivot 60 and enters the casing 1 where it is held. Prior to entering the casing the shaft passes through two seal and bearing blocks 286 and 284 with the former containing the bearing 288 and both containing numerous seals.

As the shaft enters the casing 1 another sealing block is present which features at least one seal whereby the shaft 274 is then held by the bearing 282 where the bearing 282 is held in the casing 1. A further bearing 280 is then added to the shaft and behind that the clamped spacer 276 can feature at least one locking pin. Therefore the shaft 274 is retained in a low friction rotational manner and thereby allowing the pivot point 290 to provide rotation about the centre of the shaft 274 to the first pivots 60 and thus the linear actuators and gearboxes.

The linkage 600 features the first and second gearbox and typically two linear actuators and a total of eight pivots with four first pivots 60, one at each end of each linear actuator and four pivots 290 attached to the casing and the respective four first pivots. In this case the two linear actuators 140 are at the first side of the linkage and generally parallel. As described previously if the linear actuators can move in the third (retract) or fourth (extend) directions simultaneously or independently. The linear actuators can move in the same or different directions at the same or different speeds and they can therefore generation different movement patterns for the linkage and subsequent gearboxes.

In this format if the linear actuators move simultaneously in the same direction at the same speed then at least one gearbox will move in the third or fourth direction. However if one linear actuator moves independently one gearbox will move in the first and second direction about the pivot 290. This motion is true if the linear actuators operate in the same direction (extend or retract) at different speeds or different directions (extend of retract).

However if one linear actuator is placed on the first and another is placed on the second side and both are regionally opposite such that one is in the upper region of one side and the other in the lower region of the other side then as the respective linear actuators move in the third direction (retract) and fourth direction (extend) the linkage will be able to move in the fifth and sixth direction pivoting about the pivots 60.

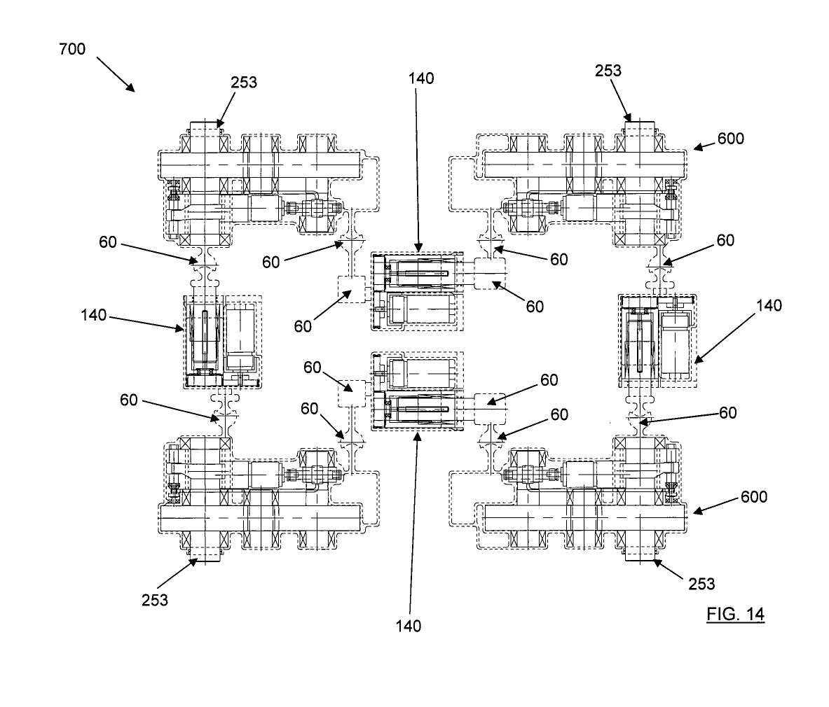

FIG. 14 shows variation of the second embodiment linkage 700 which can have all the functions and features of all the embodiments previously described. Where the components and or assemblies have been described previously they will not be described again in detail. The figure shows two linkages 600 which are pivotally attached at the first and second gearboxes at each end by linear actuators 140. The pivot attached is made at both ends of the linear actuator to the respective gearboxes by the pivots 60.

Any reference to directions such as the first, second, third, fourth, fifth, sixth seventh, eight directions and/or motion such as the circular, helix and the like are further detailed in FIGS. 6A to 6E.

The linkage 700 consists of the two linkages 600 as per FIG. 13 and this may include up to four gearboxes 251 whereby 251 is able to be the gearbox 2, 52 which has been described in FIGS. 1 to 4 or another such suitable gearbox as also described. As described in FIG. 13 the second pivots can be ball and socket pivots 60 and that is how they are shown here with the first pivots from FIG. 13 also being ball and socket pivots 60. Therefore all the pivot connections are ball socket pivots 60.

Each gearbox has an exit shaft 253 whereby 253 is able to be shaft 20, 42 or 45 from FIGS. 1 to 4 and thus there are four independent exit shafts where each end has two exit shafts and each side has two exit shafts. The exit shafts can be attached to bodies where the bodies can be rotated about the axis of the respective exit shaft or the linkage 700 can be rotated about the respective at least one exit shaft axis.

The linear actuators 140 are on the first side of the linkage 700 and connect the respective first and second gearbox of each linkage 600. The linear actuators 140 are attached to the respective first and second gearboxes of each linkage 600 via the ball and socket multi-axes pivots 60. Each linear actuator on the first side is connected to the gearboxes via two pivots 60 at each end and four in total. One pivot 60 is attached at each end of the linear actuator and the second is attached to that pivot 60 and the respective gearbox. Further linear actuators 140 are located at the first and second end of the linkage 700 and are attached via pivots 60 to both the gearboxes at each end.

Taking the overall linkage the exit shafts 253 allow the linkage 700 to be attached to a body at the first and/or second end or side such that the rotation of the exit shaft 253 will rotate the first or second end about the axis of the respective shaft 253.

Taking the first linkage 600 and the at least one linear actuator 140 which connects the first and second gearboxes. Moving the at least one actuator in third or fourth direction moves the first and second gearbox in the third and fourth direction with respect to the linear actuators 140 which are located at the first and second end. The point at which the first and second end linear actuators are pivotally attached to the first and second side first and second gearboxes will also effect the movement of the first and second gearboxes at each end and further respective to the movement of the first and second end linear actuators.

The linear actuators at each end if moved in the third (retracted) and fourth (extended) will move the first and second end first and/or second side gearboxes in the fifth and sixth directions and pivot them about the at least one first side linear actuator pivots 60 with which they are attached to the first or second gearbox.

By adding a second linear actuator located underneath the first at the first side and locating the actuators with one generally in the upper and one generally in the lower region of the respective gearboxes and both parallel at the first side the first and second gearbox as the previous figure described will be able to move the first and second direction relative to the motion of the two actuators at the first side. With the inclusion of the linear actuator at the first and second end, relative movement between the two linear actuators at the first side and those at the first and second end will allow the first and second gearbox to achieve movement in the seventh and eight directions.

A further linear can be added to the first and second end with the respective pivots 60 at each end of the linear actuator which join to the respective first and second gearbox and the first and second end. Therefore the exact movement of the first and second gearbox relative to all the linear actuator extensions and retractions allow the first and second gearbox of the first linkage 600 to be achieved in all directions simultaneously, independently, non-sequentially and at different speeds.

Therefore the direction one through to eight can be achieved with reference to FIGS. 6A to 6E. This means that each first and second gearbox of the first 600 linkage can achieve all resultant motions such as the helix motion, circular motion, the square motion and figure of eight motion simultaneously, independently, non-sequentially and at different speeds.

The second linkage can achieve the same relative directions and motions from its first and second gearbox and both linkages and therefore all gearboxes can achieve all directions and from FIG. 6A to 6D and all result motions from FIG. 6E such as the helix motion, circular motion, the square motion and figure of eight motion simultaneously, independently, non-sequentially and at different speeds.

This makes this linkage 700 totally unique and unrivalled. Preferably the linkage gearboxes are self-locking.

It will be appreciated that the output shafts 253 are able to features wheels and/or other means relevant elements to application. Wheels allow the linkage 700 to adapt to carry an object and/or load and move that load along including the ability to steer the load with respect to the result motions as described above.

As an example a linkage 700 with wheels could be a self moving, self staking and/or loading where a linkage 700 with load could climb stairs and/or the unit 700 could be the flexible arm of a hoist and/or robot and/or the body of a robot and/or a renewable energy device arm and/or a bed or workbench.

The linkage 700 due to its movement capabilities could be applied at almost any task and/or field. As with the other linkages, energy recovery, storage and deployment elements are able to be fitted. The linkage 700 is able to also have its own suspension system as described where and all relevant energy is absorbed from any direction or given back in any direction. The energy elements in the gearbox will assist in the dampening of vibration and/or sudden movement of a load. The linkage is also self framing and self supporting.

The distance between the first and second side linkage 600 in terms of the overall width as the overall length is able to be increased or decreased via the movement of the linear actuators at the first side moving in the third and fourth directions respectively.

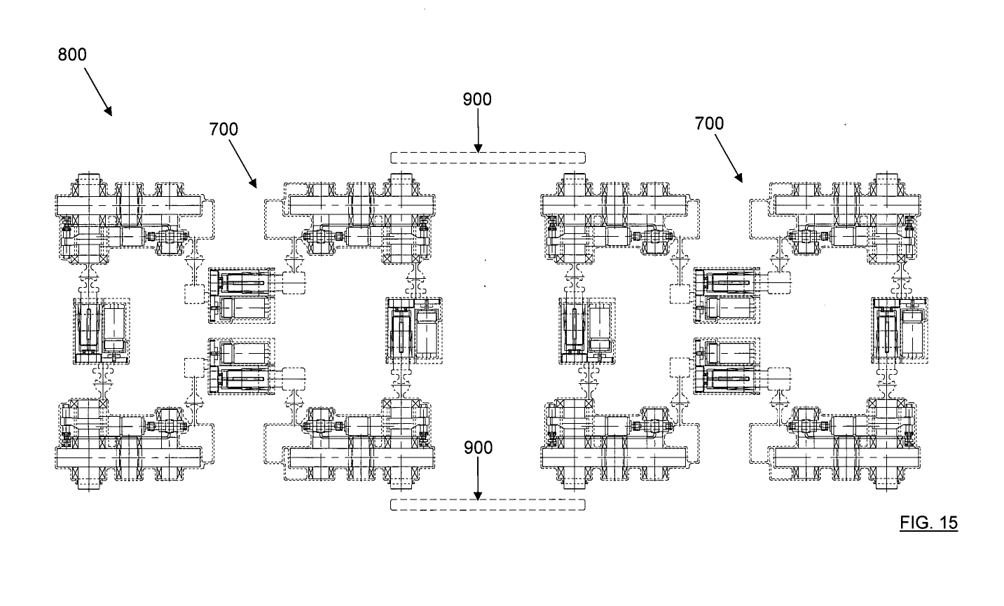

FIG. 15 shows a variation of the second embodiment a linkage means 800 made up to two linkages 700 as described in the above FIG. 14. The linkages are able to be attached via the output shafts 253 as referenced in FIG. 14. The element attaching the two linkages 700 about the exit shafts is shown as 900 where 900 is any relevant linkage included in this patent.

Therefore 900 could be a simple linkage 200 as shows in FIG. 7 or it could be a further 700 as per the previous figure. Further still the attachments could be singular items such as a gearbox 2, 52 as per FIGS. 1 to 4 or a linear actuator 140 and or even pivots 60.

Any reference to directions such as the first, second, third, fourth, fifth, sixth seventh, eight directions and/or motion such as the circular, helix and the like are further detailed in FIGS. 6A to 6E.

In this manner each linkage 700 is able to move independently or simultaneous as is each gearbox and linear actuator within each linkage 700 that makes up the linkage 800. Each linkage 700 and therefore each part of the linkage 800 are able to move in a figure of eight, a helix motion and a circular motion or square motion or any motion of relevance.

The linkage 800 is able to serve in many different applications such as a self tensioning floor and/or ceiling track and/or conveyor and/or an instance or other wise dwelling. The linkage is modular and therefore able to be applied to any field or application with a limitless number of linkages able to be attached to each other.

The linkage 800 can be used or car suspension and/or the system can be used as an active ride chassis and/or a controlled chassis for a vehicle in any form such as a motor bike and/or a car and/or truck and/or boat as well as other means such as a tank and/or tent and/or a house or industrial building.

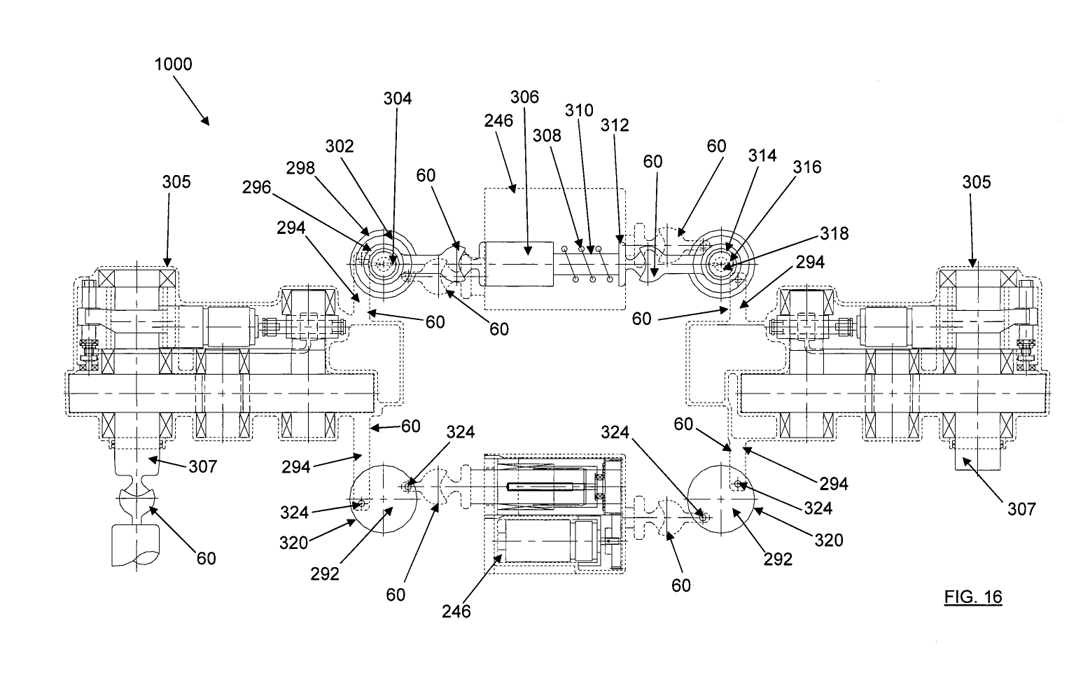

FIG. 16 the third embodiment of the linkage 1000 which is able to have any of the above described features and functions. In this embodiment the first gearbox 305 is connected to the second gearbox 305 via linear actuators 140 and energy elements at the first and second side whereby the first and second gearbox 305 are able to be the gearbox 2, 52 which has been described in FIGS. 1 to 4 or another such suitable gearbox as also described. The first and second gearbox 305 have at least one exit shaft and may be self-locking. The output or exit shafts 307 are able to be shaft 20, 42 or 45 from FIGS. 1 to 4.

Any reference to directions such as the first, second, third, fourth, fifth, sixth seventh, eight directions and/or motion such as the circular, helix and the like are further detailed in FIGS. 6A to 6E.

The linear actuators 140 and energy elements are attached to the rotary actuators via a combination of the pivot 60 and pivot 292 and the first side is the same as the second side and thus only one side will be discussed.

The first and second gearboxes 305 have extensions 294 attached or integrated and located at the first and second side respectively with the extensions able to include a pivot 60. The extensions 294 at the first and second side are located opposite each other with the first side being in the upper and the second side being in the lower regions of the first and second gearbox.

The first gearbox features the extensions at the front (the first end) whilst the second gearbox the extensions at the rear (the second end). The linear actuator 140 at the first side is connected to the lower extensions 294 via pivots 60 and 292 as shown whilst the linear actuator at the second side is connected to the upper extensions 294 via pivots 60 and 292 as shown. It should be understood that the upper and lower extensions could be present on both sides with two linear actuators (upper and lower) connected to the first and second gearbox. The connections the linear actuators 140 have with the respective upper and lower extensions are the same and as such will be described.

At the first end the pivot 292 firstly consists of two protrusions 324 on a disc 320 where the extension 294 is movably attached to first protrusion 324 in the first position which is a geometrically different position to the second protrusion 324 which is attached to the first end of the linear actuator 140 via the pivot 60 in the second position. The pivot 60 in this case is a ball and socket pivot.

At the second end the pivot 292 firstly consists of two protrusions 324 on a disc 320 where the extension 294 is movably attached to first protrusion 324 in the first position which is a geometrically different position to the second protrusion 324 which is attached to the second end of the linear actuator 140 via the pivot 322 in the second position. The pivot 60 in this case is a ball and socket pivot.

The at least one disc 320 is located at the upper or lower of end the shaft 318 corresponding to the upper or lower connections as above. Therefore the linear actuator 140 on the first side is connected to the lower disc 320 and the linear actuator 246 at the second side is connected to the upper disc 320 and as described the first gearbox is attached to the upper and lower disc 320 respect to the first and second side.

The discs allow relative movement irrespective of position between the first and second side linear actuators in terms of their fourth direction (extension) or third direction (retraction) state. As an example, if the first side linear actuator moves in the fourth direction (extends) and the linear actuator on the second side remains stationary then the second protrusions to which the second side linear actuator are attached will move from the second position to the third position, whereas the first protrusions on the second side to which the first and second gearbox are attached will move from the first to the fourth position and as such the second side linear actuator will move to the second position from its first position and as such move in a relative and generally third direction and have the same effect is if it had retracted its piston rod (as previously described) without actually having retracted its piston rod.

Conversely and it will be appreciated this is able to occur in the opposite direction with regards to a relative extension and this can be completed at both the first and second side. This arrangement allows the linkage 1000 to move in several directions simultaneously or independently and without sequence or limitation. The linear actuators can move in the third and fourth direction and as such move the second gearbox and thus the linkage will move in the first and/or second and/or third and/or fourth and/or fifth and/or sixth directions and as such a circular movement can be determined and/or a figure of eight or even a square motion. The end movements can be combined to produce a helix motion.

The advantage of the discs 320 is one of sequence in that with the disc it makes no difference to the relative position of each linear actuator in the third (retraction) or fourth (extension) and thus any movement is non-sequential. It is possible to connect at least one further linear actuator to both the first side lower and second side upper linear actuators 140 as described. This further linear actuator is connected via pivots 292 or 60 at both ends with the first end of the further linear actuator pivotally connected to the lower linear actuator on the first side and the second end pivotally connected to the upper linear actuator on the second side. The further linear actuator is such that movement of the piston rod in the third (retract) or fourth (extend) directions will induce twist of the second gearbox and thus the linkage will further simultaneously or independently move in the seventh and eighth directions.

The embodiment is able to feature an energy element 306 with a first end and a second end whereby a pivot 60 is located at both ends. The first and second end of the energy element corresponds to the first and second end of each linear actuator 140. The energy element is able to recover energy and give that energy back to the linkage 1000 as required. The energy means can be a mechanical spring or a fluid based element such as a pneumatic or hydraulic device.

The energy element 306 pivots 60 at the first and second end feature an attached collar through which the shaft 316 with a protrusion 318 is located with a bearing 314. A base disc 298 is attached by pins 304 to assist in the retention of the collar. The disc 298 via its attached relationship to the shaft 316 will rotate in accordance with the disc 320 and can all the same features and functions as the disc 320.

Further bearings can be included to assist in the lowering of friction between the discs and the collar and namely bearings 302 located above and below the collar. The energy element has a body which is able to form a chamber and which could include a valve. The energy element 306 has a shaft 310 and features a spring 308 which is located over the shaft means 310 and between the body and the end stop 312. The energy element as described could be a fluid energy element such as a shock type absorber and/or be of another much fluid system that can recovery and/or store and/or deploy energy into the system.

The geometric position between the first end and second end of the linkage changes in any given direction the shaft 310 slides in and out of the body respective to that geometric change between the first and second gearbox. If the distance between the first and second gearbox becomes less the shaft slides into the body and energy is recovered and stored via the spring or fluid element and as the distance between the first and second gearbox increases in any given direction the stored energy is released. The energy element is also able to act as a shock, impact or load bias damper and/or for vibration suppression.

It is a consideration that both the first side and second side are able to feature additional linear actuators on the upper region for the first side and the lower region for the second side. These act in the same manner as described above for the first and second linear actuators in the lower region of the first side and the upper region of the second side. These additional actuators will locate in the same manner with relation to second protrusions on a disc, but in this case the disc will be disc 298. The disc 298 will move in accordance with disc 320 and will also feature first protrusions to connect to further respective extensions from the first and second rotary actuators. The additional actuators are able to feature a cross linear actuator as referenced above.

As per the figure, the exit shafts can be attached to further linkages 1000 to form a linkage chain where each linkage 1000 is able to move in a helix pattern and/or a square pattern and/or figure eight or double circular or any combination thereof. The output shaft 307 can also include a pivoting element 60 and is able to be connected to a linear actuator 140 or another rotary actuator 52.

FIG. 17 shows the fourth embodiment of the invention 2000. This embodiment can have all the same features and functions as all the other embodiments. In this embodiment the gearbox that would be akin to a first or second gearbox as described above becomes a section. Therefore each gearbox (a first or second gearbox) becomes a section to form a gearbox section such as 2000 that incorporate many other assemblies and components as well as features and functionalities.

Each of the gearbox sections can be attached to a second section in any of the appropriate ways described above. The gearbox section has at least one gearbox 2, 52 which has been described in FIGS. 1 to 4 or another such suitable gearbox as also described.

In this case the gearboxes are shown as the lower left gearbox 703 and the lower right gearbox 705. The gearboxes 703 and 705 are able to be the gearbox 2, 52 which has been described in FIGS. 1 to 4 or another such suitable gearbox as also described. The first and second gearboxes 703 and 705 may be self-locking. The gearboxes 703 and 705 have at least one output shaft 761 which is able to be shaft 20, 42 or 45 from FIGS. 1 to 4.

Any reference to directions such as the first, second, third, fourth, fifth, sixth seventh, eight directions and/or motion such as the circular, helix and the like are further detailed in FIGS. 6A to 6E.

The gearbox section has at least one linear actuator 140. In this case the linear actuator 140 is used in different formats will be appreciated from the FIG. 5. The locking linear actuators 702 are located at the first and second side. The locking linear actuators 702 have all the same functions and features as the linear actuators 140. In this case the locking linear actuators 702 are positioned at the first and second side of the gearbox section to allow other devices to be locked onto the gearbox section.

The gearbox section has at least one surface actuator 140 and in particular at least one section 58. In this case the at least one surface actuator 701 can have all the same functions and features as the linear actuator 140 and subsequent section 58. In this case the surface linear actuators 701 are positioned across the section at various locations with respect to the desired usage.

The gearbox section further has at least one connection linear actuator 704. The connection linear actuator can have all the same functions and features of the linear actuator 140. In particular the linear actuator 704 is at least one section 56 and typically two section 56 attached side by side.

The gearbox section has a casing 14 which can have all the functions and features of all the casings/housing as described above. All the components and assemblies are held within and attached or integrated into the casing/housing 14 as shown. Therefore the gearboxes 703 and 705, the locking linear actuators 702 and the surface actuators 701 are all attached permanently or removably or integrated to form the casing and therefore form the housing or frame of the gearbox section.

The gearbox section has a surface 104 which may be moved as per that described in FIG. 5. The surface 104 which is located above the casing 14 and connected to the surface linear actuators 701 as is described in FIG. 5 with relation to the section 58. The surface linear actuators are pivotally attached to the casing and joined to the surface by the aforementioned ball extension 102 and channel portion 100. In this case six surface linear actuators are pivotally connected to the casing. However it will be appreciated that at least two linear actuators will be used.

Each surface linear actuator can move independently or sequentially in the same or different directions and at the same or different speeds to each other surface linear actuator. The movement of each surface linear actuator can therefore be used to move the surface of the gearbox section.

For example, the first surface linear actuator could extend which would lift a section of the surface and pivot the surface relative to the pivotally connection of each surface linear actuator via the pivotally connection 60 they have with the casing 14 and/or the pivotal connection formed with the section 112 and the ball extension 102 of the surface.

As the surface linear actuator in this case as the first surface linear actuator lifts in a vertical manner via the piston rod extending the surface due to the other surface linear actuators not moving will raise and become generally angled. This means that the surface will pivot about the pivotal connection 112/102 and the pivotal connection 60 of all the surface linear actuators.

One part of the connection the at least one surface linear actuators have with the surface is the connection 90 with the channel portion 100. In the first axis the surface pivots about the connection 112/102 where the arm 90 and the channel 92 allow the surface to freely pivot yet the end stop 94 maintains a relative fixed surface such that the relationship between the surface and the connection the 112/102 is maintained and the surface does not disengage from the surface linear actuator and is safe. In the second axis the surface pivots about the connection 112/102 yet in this case the arm 90 will also pivot relative to the movement of the surface about its pivotal connection with the section 112 which has been described in FIG. 5.

In this way the surface is moveably attached to the gearbox section 2000. The surface and surface linear actuator connections ensures that relative movement in any axis can take place between the surface and the at least one surface linear actuators yet the surface is always retained to the at least one surface linear actuators. The surface linear actuators are also pivotally attached to the casing via the pivotal connection 60 and as such the surface linear actuators themselves can move relative to the surface and therefore relative to the movement and the extension or retraction of all other surface linear actuators.

Therefore the surface linear actuators can move relative to the movement of the surface 104 as a function relative to input of the surface linear actuators. This means that the surface is highly moveably and can lift in a pure vertical manner where all the surface linear actuators extend simultaneously at the same time and at the same rate or any one part of the surface can be generally higher than any other part of the surface where at least one surface linear actuator moves independently in terms of direction and/or speed to at least one other surface linear actuator. Therefore surface can pitch and roll as well as raise and lower in any combination and at any point on the surface and this can occur on a continuous cycle to form a helix motion or derivative thereof or in discrete motions as a vertical motion.

The gearboxes 703 and 705 have at least one shaft 761 and at least one shaft where a connection linear actuator 704 is positioned. This allows connection to another gearbox section whereby the other gearbox sections would be permanently or removably attached. The gearbox section to which this gearbox section 2000 is being attached would also feature at least one shaft and at least one connection linear actuator and once the gearbox sections are attached they would form a first and second gearbox section arrangement. Typically these connection linear actuators and shaft would be the mirror of each other and as such the connection linear actuator from one would fit to the shaft of the other.

The connection linear actuators of each section when moved simultaneously would in terms of extending would move the shafts 42 away from each other and thus move the gearbox sections away from each other and when they retract they would move the gearbox sections closer to each other. As such the gearbox sections will move relatively in third and fourth direction.

If the connection linear actuators move in different directions and or at different speeds then first gearbox section will “yaw” and that is to say the first linear actuator will move in the first fifth and sixth direction. The movement will be limited unless a pivotal connection is incorporated into the connection between the first and second gearbox section. At least one pivotal connection such as 216 from FIG. 7 can be incorporated into the connection between the connection linear actuators of the first and second gearbox sections.

Once the first and section gearbox sections as attached the first and/or second section are able to operate and rotate. Therefore as the first gearbox section rotates it will rotate about the at least one shaft 761 in the first and second direction and as the second gearbox section rotates it will rotate about the at least one shaft 761 in the first and second direction.

Each gearbox section can rotate in the same or different directions simultaneously or independently at different of the same speeds.

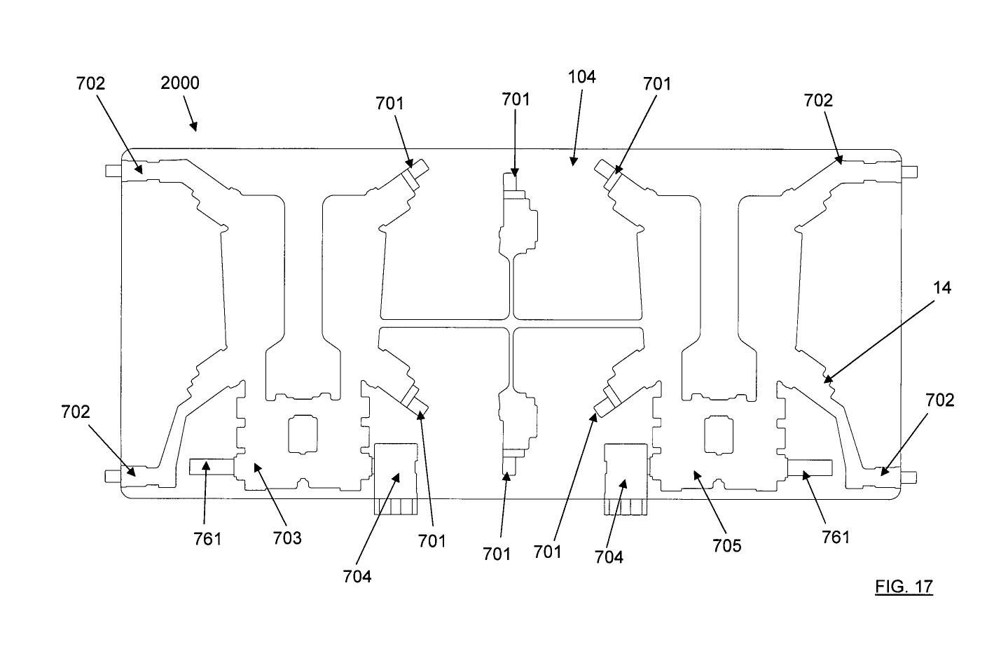

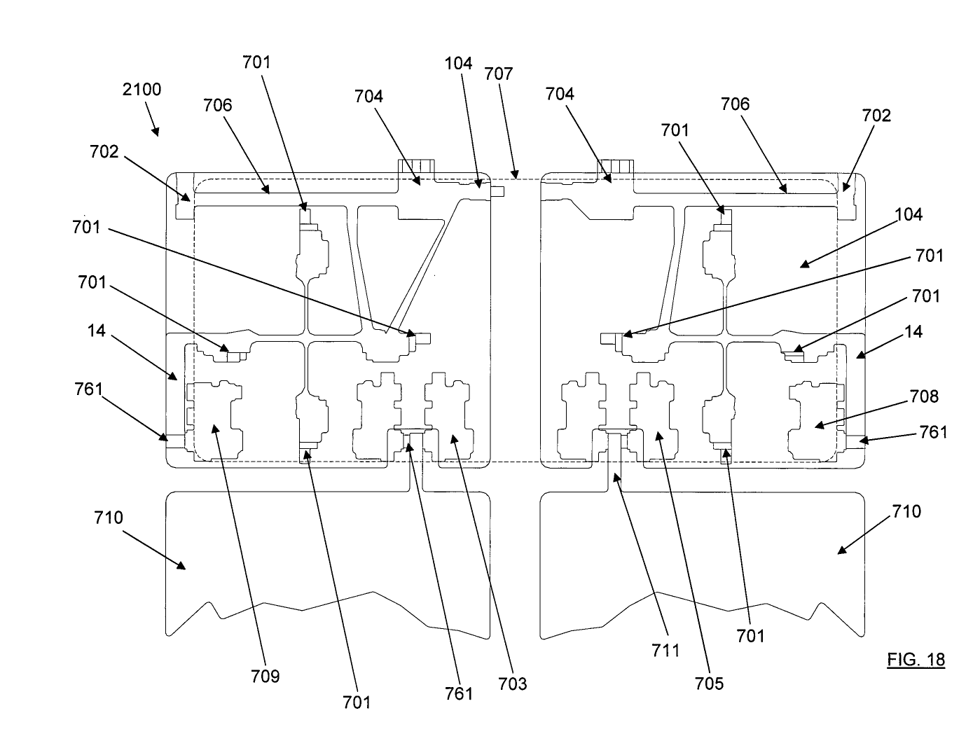

FIG. 18 a variation of the fourth embodiment, a gearbox section 2100 and this gearbox section can have all the same functions and features as all other embodiments and in particular the gearbox section 2000. If components and assemblies have been described in detail previously they will not be described in detail herein, unless for a particular reason.

The sections gearbox section 2100 has the same surface linear actuators as the previous gearbox section and features locking linear actuators 702. The section also features the gearbox 703 and gearbox 705 as well as gearboxes 708 and 709. The gearboxes 708 and 709 are able to be the gearbox 2, 52 which has been described in FIGS. 1 to 4 or another such suitable gearbox as also described. The gearbox 708 and 709 may be self-locking.

The gearboxes 708 and 709 have at least one output shaft 761 which is able to be shaft 20, 42 or 45 from FIGS. 1 to 4.

Any reference to directions such as the first, second, third, fourth, fifth, sixth seventh, eight directions and/or motion such as the circular, helix and the like are further detailed in FIGS. 6A to 6E.

In this gearbox section, the gearbox section is sub split into two halves/or sub sections in a similar manner to the FIG. 14 which also feature a first side and section side. In this case the first side and second side feature the same components and assemblies and are of a mirrored type layout and have the same operation and therefore only one side will be described in detail and it will be appreciated that the second side is functionally the same.

Unlike the previous figure the section 2100 is has the gearboxes 703, 705 and 708 and 709 attached permanently or removably to a body 707 whereby the relationship is sufficient to retain the gearboxes whilst they rotate their output shafts 761. Each sub section as before has all the assemblies attached to each other permanently or removably or integrated to form a casing or frame 14 with the exception of the gearboxes. The gearboxes are attached or integrated to the body 707 and permanently. The gearboxes 708 and 709 are removably or permanently attached or integrated to the frame 14 via the output shafts 761. The casing further includes a bar connection bar 706 and at least one set of connection linear actuators 704 on the third side that are attached or integrated with the bar 706.

The gearboxes 703 and 705 have an output shaft that is connected to the portion 711 of the section 710. The gearboxes are held sufficiently as described to the body 707 and therefore rotation of the gearboxes shaft 761 will rotate the sections 710 about the axis of the shaft 761. The gearboxes 703 and 705 can rotate independently or simultaneously in the same or different directions and at the same or different speeds and thus the sections 710 can be rotated independently or simultaneously at the same or different directions

The gearboxes 708 and 709 have output shafts that attach to the casing 14 and like gearboxes 703 and 705 they are held sufficiently by the body 707 such that the rotation of the output shafts rotates frame 14 and it assemblies and component and thus rotates the surface 104 as well as the surface linear actuators 701 the locking linear actuators 702, the connection linear actuators 704 and the bar 706 about the axis of the gearbox 708 and 709 respectively. Each sub section frames 14 and hence the gearboxes 708 and 709 can independently or simultaneously rotate at the same or different directions.

The connections bars 706 and connection linear actuators 704 allow other gearbox sections such as the gearbox section 2000 to attach to this section. For example the gearbox section 2000 can engage the connection linear actuators 704 with regards to the section 2000 shafts 761 of the of the gearboxes 703 and 705 as the connection linear actuators of the section 2000 can engage with the bar 706.

Therefore a first and second gearbox section arrangement is formed and is as has been described above where the connection linear actuators can alter the relative distance between the sections and thus in this case the bar 706 and the shafts 761 of the connecting gearbox section.

In this case the second gearbox section and for example gearbox section 2000 can rotate independently of the gearboxes in this section 2100. However, once attached the gearbox section 2000 would rotate with the frame 14 of this section 2100 as the gearboxes 709 and 708 rotate their shafts 761 as described.

The section 2100 can also be joined on the third side where the bar 706 is located by a section that is also split into sub sections. As such each sub section would be attached via connection linear actuators and shafts as described to the sub relevant sub section of the section 2100. In this case the locking actuators could also be used in that they can be extended as a male part and received into female part on the sub section which is being attached.

This locking linear connection allows the relationship between each sub section to be locked such that no rotation of the joined sub section will occur. This feature can also be included in the joining of other sections such as section 2000 as described.

FIG. 19 a variation of the fourth embodiment, the gearbox section 2200 and this gearbox section can have all the same functions and features as all other embodiments and in particular the gearbox sections 2000 and 2100. If components and assemblies have been described in detail previously they will not be described in detail herein, unless for a particular reason.

The gearboxes 703 and 705 like are attached and or integrated into the respective casings 14 along with the other attached assemblies such as the surface linear actuators 701 and the connection linear actuators 704. In this case both the frames 14 are integrated with the body 707.

The gearbox section operates in the same manner as has been described, other sections are able to attach to the third side as per the side which the bar 706 is closest to and runs parallel with and the fourth side where the gearboxes 703 and 704 are located.

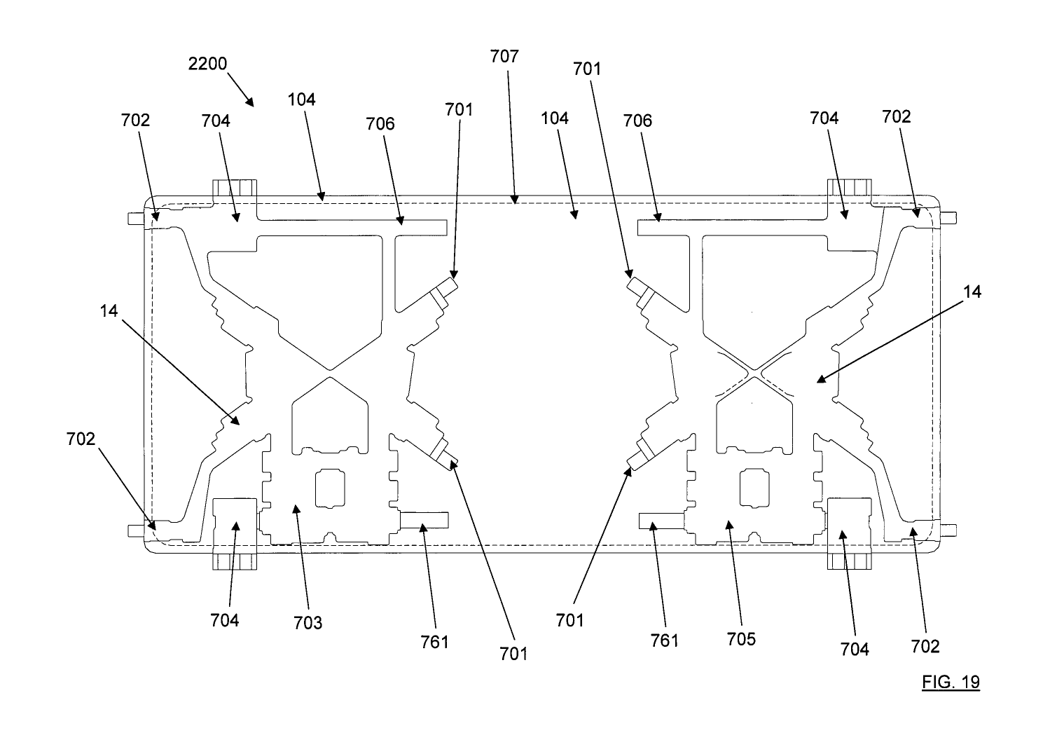

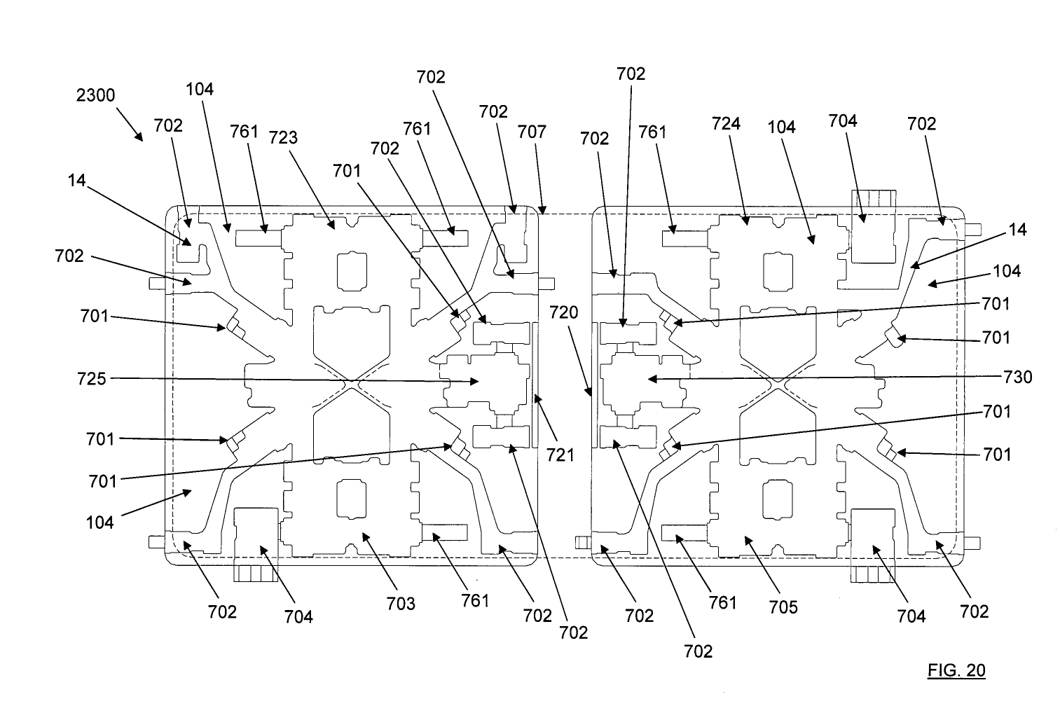

FIG. 20 shows the gearbox section 2300 and this gearbox section can have all the same functions and features as all other embodiments and in particular the gearbox sections 2000, 2100 and 2200. If components and assemblies have been described in detail previously they will not be described in detail herein, unless for a particular reason.

Any reference to directions such as the first, second, third, fourth, fifth, sixth seventh, eight directions and/or motion such as the circular, helix and the like are further detailed in FIGS. 6A to 6E.

This section like gearbox section 2100 in FIG. 18 is split into halves or sub sections. Each sub section has an independent frame with the various assemblies in each independent frame as have been described before such as the linear locking actuators 703, the gearboxes 703, 705 and the surface linear actuators 701.

As has been described gearboxes 703 and 705 are able to be the gearbox 2, 52 which has been described in FIGS. 1 to 4 or another such suitable gearbox as also described. The gearboxes may be self-locking and have at least one exit shaft 761. The exit shaft 761 is able to be shaft 20, 42 or 45 from FIGS. 1 to 4.

However in this case each frame has a double gearbox arrangement that is a gearbox at each end of the linkage section. The extra gearboxes respective to each sub frame/each side are the gearboxes 723 and gearbox 724. The gearboxes 723 and 724 are able to be the gearbox 2, 52 which has been described in FIGS. 1 to 4 or another such suitable gearbox as also described. The gearboxes may be self-locking and have at least one exit shaft 761. The exit shaft 761 is able to be shaft 20, 42 or 45 from FIGS. 1 to 4.

The gearboxes 723 and 724 can be the same or different to the gearboxes 703 and 705. The gearbox 723 and 724 can rotate in the same direction as other and the gearboxes 703 and 705 or they can rotate in a different direction and/or at different speeds. Like 703 and 705 they are integrated into the respective frame 14 and have shafts 761 that can be attached permanently or removably to connection linear actuators 704.

Further each sub section and sub frame 14 has a further gearbox on the respective first and second side respective to the sub section. These further gearboxes 725 and 730 are orientated generally perpendicular to the gearboxes 703, 705 and 723 and 724 of the respective sub sections.

The gearboxes 725 and 730 are able to be the gearbox 2, 52 which has been described in FIGS. 1 to 4 or another such suitable gearbox as also described. The gearboxes may be self-locking and have at least one exit shaft 761. The exit shaft 761 is able to be shaft 20, 42 or 45 from FIGS. 1 to 4.

All the gearboxes can rotate in the same direction or they can rotate in a different direction and/or at different speeds and all gearboxes can operate individually and or simultaneously.

The gearboxes 725 and 730 include the connection linear actuators 702. The connection linear actuators connect to a station 721 or 720 depending on the sub section. The stations 721 and 720 are removably or permanently attached or integrated to/with the base 707.

All other functions and features are as described, each section can feature the moveably surface 104 which can move independently for each section and each section can engage with other sections. However these sections can also rotate about the centre and described just one side. The first side connection linear actuators 704 which are engaged to the station 721 can operate and move the first side/sub section away from the other in a similar manner to the gearboxes in FIG. 14 and FIG. 15.

This means that each section can move in the third and fourth direction perpendicular to the movement in the third and fourth direction resulting from the connection members 704 associated with the gearboxes 703, 705, 724 and 723. This means that the section can feature two third and fourth directions of movement with both being perpendicular to the other.

With the extension to a suitable distance, the gearbox 725 can operate and rotate the first section including the frame 14 and all other components and assemblies about the axis of its shaft 761. The second sub section operates in the same manner however instead it is the gearbox 730 that rotates to rotate the second section about its axis.

In this case locking linear actuators 702 are provided between the sub sections on the first edge of the second sub section and the second edge of the first sub section. These linear locking actuators are as described previously, as one advances on one sub section the other retracts and thus either can be a male or female parts. These locks will lock the sections together and keep them effectively as one piece albeit with separate independently moveably surfaces 104.

Other sections can be added to these sections as full section such as section 2000 or as separate sections where each sub section will receive an individual section. It will be appreciated that if a full section such as 2000 is added that spans both these section only one sub section would be able to rotate about the axis of the gearbox 725 or 730.

It is also seen that the gearbox section has up to four active shafts, taking the second sub section each of the shafts from the gearboxes 724 and 705 located at each end of the sub section can rotate at different speeds and/or in different directions and/or at different times although typically they would rotate at the same rate in the same direction.

Other sections can be added to the first end and the second end corresponding to the third and fourth sides for both sub sections. As in other cases in this embodiment, a connecting section will have gearboxes via shafts and/or connection linear actuators which connect to the gearboxes via shafts and/or connection linear actuators of these this section as a whole or each sub section individually.

As such and as has been described before, the first gearbox section which is being attached to the second gearbox section can rotate (move in the first and second direction from FIG. 6A to 6E) about the axis of its gearboxes as the second gearbox section can rotate the first gearbox section and the connection linear actuators (move in the first and second direction) about the axis of its gearboxes with the connection linear actuators being able to move each the first and second gearbox section closer or further apparent and as such move them in the third and fourth direction. This is true of all at least one gearbox sections.

This is advantageous as it means that the section can “roll” up and/or fold up as well as enabling them to complete many types of movement. As well as being suitable for hospital beds and the like this is also advantageous in other fields such as a folding work bench for a vehicle or a movement and flexible chassis and/or body for a vehicle or other usages like an expanding dwelling or the hull of a ship or boat that is able to expand and alter shape. The system is also advantageous for other modes of transport such as airships and/or other aircraft such that the shape can change to suite the needs without altering the weight of the unit.

FIG. 21 shows a variation of the fourth embodiment, the gearbox section 2400 and this gearbox section can have all the same functions and features as all other embodiments and in particular the gearbox sections 2000, 2100, 2200 and 2300. If components and assemblies have been described in detail previously they will not be described in detail herein, unless for a particular reason.

The section consists of a frame 14 to which all the components and assemblies are permanently or removably attached or integrated. The section is able to engage with at least one other section. The third and fourth sides (the end) feature the gearboxes 703, 705, 723 and 724 as has been described above. These gearboxes have shafts and connection linear actuators to allow gearbox section to engage at the third and fourth sides as has been described.

The section has a moveable surface 104 with at least two surface linear actuators akin to all other sections. The section also features locking linear actuators that can allow other devices and section to be joined and again this can true of all sections.

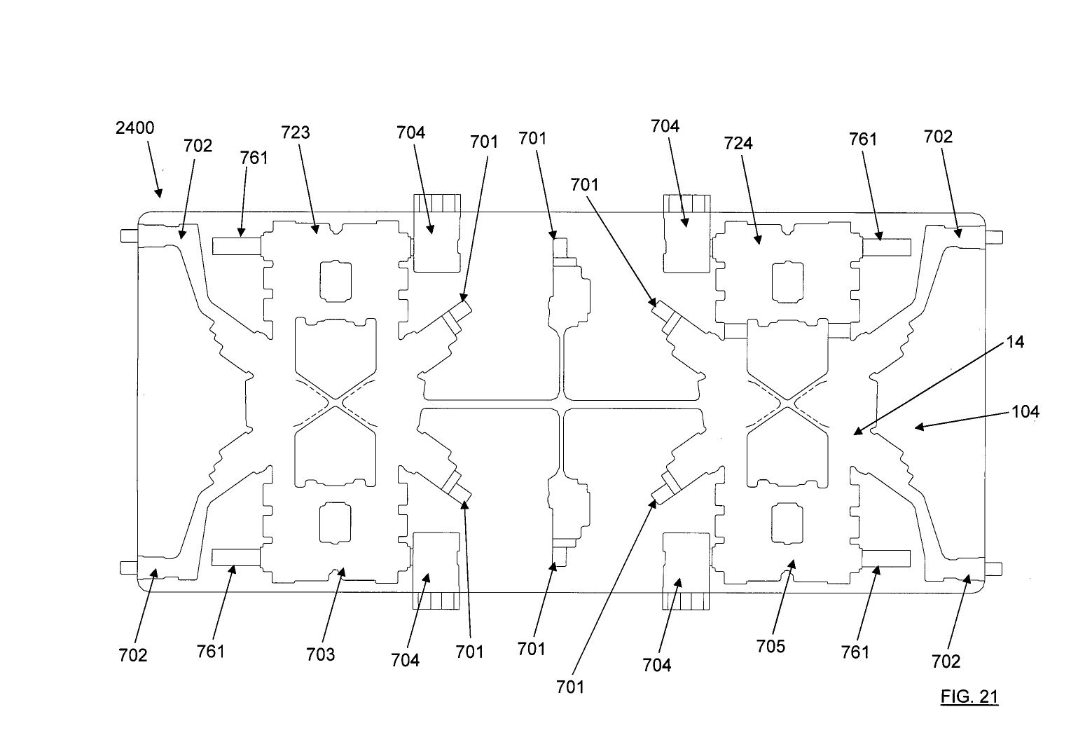

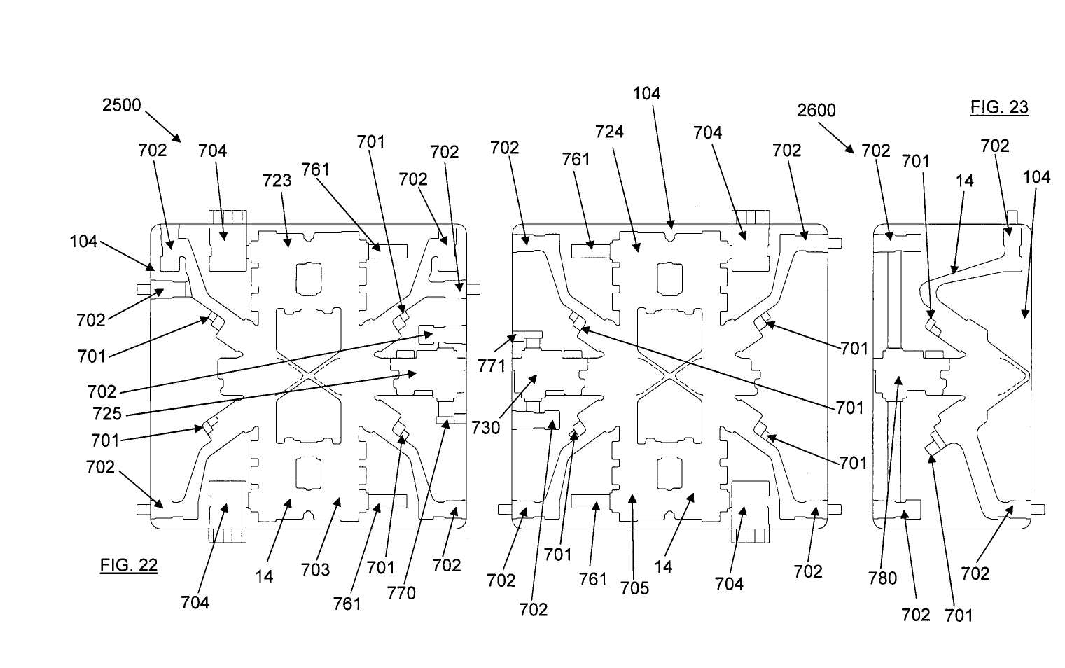

FIG. 22 shows a variation of the fourth embodiment, the gearbox section 2500 and this gearbox section can have all the same functions and features as all other embodiments and in particular the gearbox sections 2000, 2100, 2200, 2300 and 2400. If components and assemblies have been described in detail previously they will not be described in detail herein, unless for a particular reason.

The section is split into sub sections and is exactly the same as the sub sections described in FIG. 20 however, their some differences that will be herein described. As with all the sections each sub section has a frame or casing 14 to which all the components and assemblies are permanently or removably attached or integrated. The sub sections include the surface linear actuators 701, the locking linear actuators 702 and the connection linear actuators 704 which all have the same features and functions as the linear actuator 140 and all derivatives thereof. This is true for all gearbox sections where these are used.

The sub sections have the gearboxes 703, 723 and 725 for the first sub section and 705, 724 and 730 for the second sub section whereby these gearboxes is able to be the gearbox 2, 52 which has been described in FIGS. 1 to 4 or another such suitable gearbox as also described. The gearboxes may be self-locking. The gearboxes have at least one exit shaft 761 is able to be shaft 20, 42 or 45 from FIGS. 1 to 4.

Any reference to directions such as the first, second, third, fourth, fifth, sixth seventh, eight directions and/or motion such as the circular, helix and the like are further detailed in FIGS. 6A to 6E.

The difference to the FIG. 20 is that this figure has no body 707 and thus the pivoting action is relative to the gearboxes 725 and 730 without any further station. The gearboxes 725 and 730 have locking linear actuators and docking units 771 and 770, the docking units being opposite to the locking linear actuators. The locking linear actuators can extend and are thus male parts as the docking units are female parts.

Therefore the male parts extend via operation of the linear actuator and engage the female parts. Once docked the male part locking linear actuators keep extending and move the sub sections in the third and fourth direction which is perpendicular to the third and fourth direction of the connection linear actuators. The sub sections once a suitable distance are then free to rotate about the axis of the gearbox 725 or 730 respectively.

In this arrangement the first sub section will support the second sub section and as such only one sub section can rotate at any one time where the other sub section is support via the connection of the respective gearbox shaft and connection linear actuators to another sub or full section.

If this arrangement is connect to the arrangement in FIG. 20 then both the sub sections can rotate at the same time with the respective sub sections from FIG. 20. This is due to the sub section in FIG. 20 being provided with a base 707.

In a further alternative, the sub sections locking linear actuators 702 on the third edge can move into position with a location on an a joining gearbox section and as such both sections will be able to pivot about the relative axis of the respective gearbox 725 or 730 and linear locking actuator.

FIG. 23 shows a variation of the fourth embodiment, the gearbox section 2600 and this gearbox section can have all the same functions and features as all other embodiments and in particular the gearbox sections 2000, 2100, 2200, 2300, 2400 and 2500. If components and assemblies have been described in detail previously they will not be described in detail herein, unless for a particular reason.

Any reference to directions such as the first, second, third, fourth, fifth, sixth seventh, eight directions and/or motion such as the circular, helix and the like are further detailed in FIGS. 6A to 6E.

As with all other gearbox sections the section has a gearbox 780. The gearbox 780 is able to be the gearbox 2, 52 which have been described in FIGS. 1 to 4 or another such suitable gearbox as also described. The gearbox may be self-locking and have at least one shaft which is able to be shaft 20, 42 or 45 from FIGS. 1 to 4.

In this case the gearbox is removably or permanently attached or integrated with the locking actuators 702. The gearbox is permanently or removably attached or integrated to the frame 14 which also houses other locking linear actuators 702 and linear surface actuators 701. The unit has a surface 701 which as described can be moved via the input of the surface linear actuators.

The section can be applied to the any of the sections above on the first or second side and locks in position with the sections with the use of the locking linear actuators. As has been described the locking linear actuators can be both males and female and when this section is placed against another section in this case the locking linear actuators of each section can extend or retract to allow the other sections locking linear actuator to enter the respective bore housing. This can be true of all the sections and like all the sections the locking linear actuators can also feature a shaped section 110 that can also be utilised for docking and securing of additional sections. When the locking linear actuators are in position the gearbox 780 is free to rotate the section about its axis.

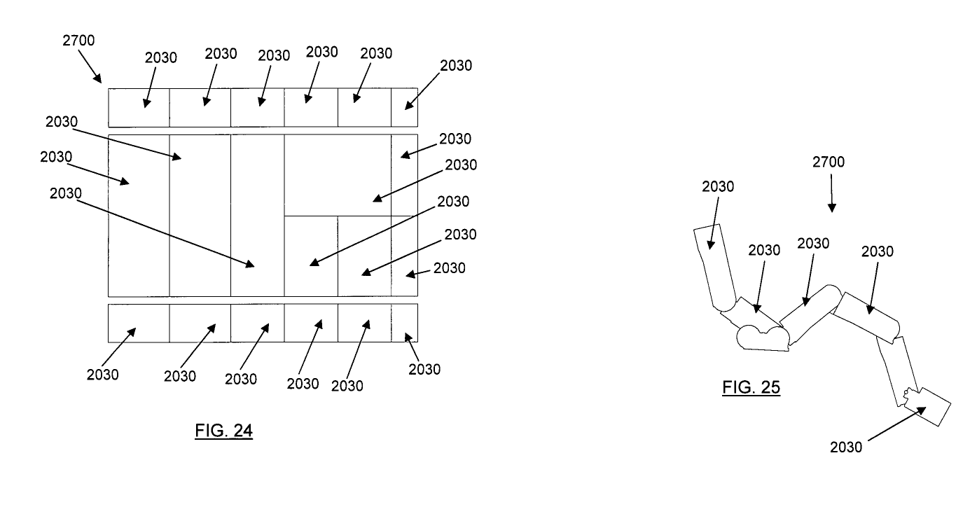

FIG. 24 shows a multiple form of the fourth embodiment, the multi-axes section 2700 and this can be formed from at least two of any of the gearbox sections 2600, 2000, 2100, 2200, 2300, 2400 and 2500. Collectively the sections are termed as 2030.

All the gearbox sections can be engaged as described above using the locking linear actuators and on any edge. With at least two sections 2030 engaged they form an expandable multi-axes chain linkage whereby linkages 2030 as described above of different sizes can be placed together and therefore a multi-axes gearbox sectional linkage can be formed.

Each of the gearbox sections can move independently or simultaneously with any other gearbox section and without any sequence. The formation of the at least one gearbox section has a multi-variable and multi-axes surface where each gearbox section surface can move independently of another.

The at least two gearbox section 2030 formation 2700 can extend and or retract both across its width and the length as the locking and/or connection linear actuators extend and retract.

The at least two gearbox sections can have at least one strand.

The multi-axes formation 2700 can be a bed or chain or conveyor or dental chair or workbench or any other suitable aspect with the application from buildings to vehicles to armoured means and or flying means and or as referenced for the hull of a boat whereby the linkage can be any size and or shape.

The gearbox sections can be as referenced any size or shape including hexagonal and or circular.

An advantage of the formations 2700 expandability is that the overall size of the surface can be changed. For example, if a two strand surface was being used as a bed or a chain, the size can be altered to suit an adult or a child, where further gearbox sections 2030 of different sizes and width can be removed or added as desired.

This is further advantageous in hospitals where the beds for example could be required to treat a bariatrics patient. The expandable nature of the unit with the addition of the gearbox sections 2030 as desired means that further gearbox sections can be added to meet the increased width requirements. Conversely if the next patient was a child gearbox sections could be removed and the bed could be then used as an incubator or child sized bed.

FIG. 25 shows formation 2700 whereby the individual gearbox sections 2030 move to form a shape. The length of each gearbox section can be perfectly matched to a person's anthropometric data and thus the gearbox section 2030 can be exactly matched not only to the person's size but also to their need whereby the helix motion of each gearbox sections surface will inhibit pressure soars and or other related long term care and pressure associated afflictions.

Each gearbox section 2030 may include electronic or computer control or monitoring, and this may be implemented using hardware, firmware, software or a combination of these. A gearbox section 2030 may communicate through wired or wireless communication with other gearboxes or other components, such as servers or computers, and this can be used to exchange data including new programs and/or other software updates.

The gearbox section 2030 can include suitable electrical means 3, for example sensor mean(s), electrical connection(s), electronic circuit(s), wiring loom(s), programmable or not programmable circuit board(s), microchip(s) and/or other component(s) or assembly capability.

Where provided, the sensor means can include sensors or sensor arrays to sense parameters such as torque, power consumption and/or electrical characteristics.

The gearbox section 2030 can incorporate visual data screens as well as LEDs or other light emitting components or assemblies to display information about the gearbox sections 2030.

The electronic control and/or sensing allow a number of gearboxes sections and/or other devices to be provided in a network and to allow them to be operated together effectively.

A number of gearbox section according to embodiments of the present invention can advantageously be connected together to form a collective. In the simplest arrangement, two like gearbox sections can be coupled together, although any number and type of gearboxes can be couple together as desired.

When in a network, the gearbox sections are able to process, exchange and/or store programs and data for/with other gearbox sections, devices, computer means, electronic devices and/or electrical human interaction device.

The gearbox sections can have a unique computer readable address, name and/or other unique identifier that can be used to not only identify the capabilities of the gearbox section but also certificate and authenticate the section.

The gearbox section can have a computer readable data storage means that can store information such as the capabilities of the gearbox section, when it was last serviced and/or inspected, when it was manufactured and any and/or all other parameters and/or programs deemed relevant.

The gearbox section is able to send information relating to the gearbox or its operation to other gearbox sections or other devices such as computers, for example to allow the other gearbox sections or other devices to determine how they should operate or to determine how the gearbox section itself should be operated. The gearbox section is also able to receive information, for example from sensors of the gearbox section or from external sources, such as other gearbox sections or other devices such as computers to control the operation of the gearbox section based on this information.

The gearbox sections are able to assess the operation they are being requested to complete against their at least one installed program and compare and/or modify their operation against any parameters that are associated with at least one network they are held within and/or connected to, their location, the at least one operator, the at least one body and/or other upon which they are acting and/or interacting and/or associated with.

The gearbox sections are able to send and receive error messages whereby they are able to send data and receive data if the programmed parameters and/or mechanical systems have been exceeded, enacted, fulfilled or not fulfilled.

1. A linkage comprising a first gearbox having a first driven shaft, a second gearbox having a second driven shaft, and at least one linear actuator connected between the first gearbox and the second gearbox arranged such that the actuation of the at least one linear actuator adjusts the relative position of the first and second driven shafts.

2. A linkage according to claim 1, further comprising at least one additional linear actuators between the first and second gearboxes, the linear actuators being arranged such that the actuation of one or more of the linear actuators adjusts the relative position of the first and second driven shafts.

3. A linkage according to claim 2, in which a further linear actuator is provided between the linear actuators.

4. A linkage according to claim 1, in which the or each linear actuator is self-locking or otherwise able to be maintained in a fixed position.

5. A linkage according to claim 1, in which at least one end of the at least one linear actuator is pivotally connected to one of the gearboxes.

6. A linkage according to claim 5, in which each end of the at least one linear actuator is pivotally connected to the respective gearbox.

7. A linkage according to claim 5, in which the at least one end of the at least one linear actuator is pivotally connected to one of the gearboxes by attachment to the driven shaft of the gearbox.

8. A linkage according to claim 1, in which the first and second gearboxes are pivotally connected by a pivoting joint.

9. A linkage according to claim 8, in which the pivoting joint comprises a hinge or a ball and socked type joint.

10. A linkage according to claim 1, in which at least one additional linear actuator is connected to the first or the second gearbox.

11. A linkage according to claim 10, in which a further gearbox is connected to the at least one additional linear actuator.

12. A linkage according to claim 11, including a first gearbox, a second gearbox and a third gearbox with a first linear actuator connected between the first gearbox and the second gearbox and a second linear actuator connected between the second gearbox and the third gearbox, in which the first linear actuator is offset from the second linear actuator such that the third gearbox can be located between the first and the second gearbox.

13. A lifting mechanism comprising at least one linkage according to claim 1 such that the driving of the shaft of the first gearbox will cause the movement of the linear actuator and therefore the movement of the second gearbox connected to the linear actuator with respect to the base.

14. A lifting mechanism according to claim 13, in which the second gearbox includes an arm for connection to a further gearbox or lifting means.

15. A surface including a first surface section and a second surface section, and a linkage according to claim 1, the first surface section being mounted with respect to the first gearbox and the second surface section being mounted with respect to the second gearbox arranged such that the first and second surface sections are movable with respect to each other as the first and second gearboxes are moved with respect to each other.

16. A surface according to claim 15, in which the first and second surface sections are fixedly mounted to the first and second gearboxes respectively.

17. A surface according to claim 15, in which the first and second surface sections are mounted to the first and second gearboxes in a manner permitting relative movement between the surface section and the gearbox.
